(19) United States
(12) Patent Application Publication
(10) Pub. No.: US 2014/0342397 A1
(43) Pub. Date: Nov. 20, 2014

(54) Particle Detection Device and Method

(71) Applicant: Grundfos Holding A/S, Bjerringbro (DK)

(72) Inventors: Jens Andersen Gad, Copenhagen Ø (DK); Heidi L. Enemark, Vaerlose (DK); Mohammad Nafi Solaiman Al-Sabi, Vanlose (DK); Jørgen Kurtzhals, Copenhagen Ø (DK)

(73) Assignee: Grundfos Holding A/S, Bjerringbro (DK)

(21) Appl. No.: 14/361,558

(22) PCT Filed: Dec. 21, 2012
(86) PCT No.: PCT/DK2012/050497

§ 371 Date: May 29, 2014

Related U.S. Application Data
(60) Provisional application No. 61/592,096, filed on Jan. 30, 2012.

(30) Foreign Application Priority Data
Dec. 21, 2011 (EP) 11195044.0
Jan. 30, 2012 (DK) PA 2012 70048

(51) Int. Cl. G01N 21/01; B01D 29/60; B01D 39/10; B01D 29/66; B01D 29/00

(52) U.S. Cl. CPC G01N 21/01; B01D 29/66; B01D 29/0095; B01D 39/10; B01D 29/606; B01D 29/603
USPC 435/34; 210/791; 210/798; 210/407; 210/85; 210/741

(57) ABSTRACT

The invention relates to a device and a method for detecting particles, in particular parasites, in drinking water adapted to on-line application. In particular, the invention b) relates to a method for detecting parasites in water, said method comprising: Passing at least a part of the water through a filter; Applying indirect sonication with ultrasound to said filter to release parasites which have been collected in said filter without disrupting said parasites; Collecting parasites for detection; and Detecting the collected parasites. This serves to collect parasites in the filter and/or increase the concentration of parasites before the filter and/or disrupt aggregates without disrupting the parasites per se. The invention further relates to a concentration device for filter filtration concentration of particles from a volume of a fluid. The concentration device comprises an ultrasonic transducer that is configured to clean the filter.

The present invention relates to a device and a method for detecting particles, in particular parasites, in water. In particular, the invention relates to a device and a method of detecting parasites in drinking water adapted to on-line application.

### TECHNICAL BACKGROUND

In the industrialized world approximately half of the population has a water supply based on treated surface water. The protozoan parasites Cryptosporidium and Giardia are the most common water borne diseases infecting as many as 50 out of 100.000 persons per year (O′Donoghue Pt Cryptosporidium and cryptosporidiosis in man and animals. Int J Parasitol. 1995 February; 25(2):139-95. Yoder J S, Harral C, Beach M J; Centers for Disease Control and Prevention (CDC). Giardiasis surveillance—United States, 2006-2008. MMWR Surveill Summ. 2010 Jun. 11; 59(6):15-25. Yoder J S, Harral C, Beach M J; Centers for Disease Control and Prevention (CDC). Cryptosporidiosis surveillance—United States, 2006-2008. MMWR Surveill Summ. 2010 Jun. 11; 59(6):1-14). Both parasites cause disease outbreaks at regular intervals, in most cases due to spread through the water supply. The water contamination may occur both before and after the waterworks making monitoring of water supply at both central and peripheral levels relevant for the prevention of such outbreaks.

Many countries have regulations requiring regular testing for Cryptosporidium and Giardia. Contemporary methods for detecting Cryptosporidium and Giardia are, however, expensive and labour-intensive delaying test results for 1-3 days, which is too late to take action and prevent an outbreak.

The International patent applications WO 2010 063293 A1 and WO 2011 066837 A1 describe optical measurement systems applicable for the detection of biological entities.

An article, “Early warning system for detection of microbial contamination of source waters”, by Mogensen, Claus Tilsted et al., reputedly online of 16 May 2011, concerns an online and real-time sensor for measuring the microbial water quality of a wide range of source waters.

The International patent application WO2008151093 describes a cross-flow filtration system which concentrates biological particles that are suspended in liquid from a dilute feed suspension. A sample concentrate or retentate suspension is retained while eliminating the separated fluid in a separate flow stream. Suspended biological particles include such materials as proteins/toxins, viruses, DNA, and/or bacteria in the size range of approximately 0.001 micron to 20 microns diameter. Concentration of these particles is used for detection of target particles in a dilute suspension, because concentrating them into a small volume makes them easier to detect.

The International patent application WO2011042254 describes a biosensor device which comprises a filter monitoring unit for the automatic monitoring of the function of a filter present in the biosensor device. The filter monitoring unit comprises a plurality of sensors which monitor the differential pressure across the filter, the flow quantity through the filter, the mechanical stress on the filter and other parameters. If the filter monitoring unit detects a clogging of the filter, it activates a cleaning unit which cleans the filter. If it detects damages to the filter, it outputs a signal indicating that maintenance is required.

The International patent application WO2006080761 describes an automatic chlorophyll analyzer and an analytical method for measuring fluorescence of chlorophyll after automatic processes of sample filtration and pigment extraction is disclosed, wherein the analyzer comprises: a flow path for fluid transfer; a multi-port valve for selectively connecting one of its ports with the said flow path; a filter for separating particulate materials from water sample and chlorophyll extract; a detector for measuring the fluorescence of chlorophyll extract; a syringe pump for picking up or dispensing the water sample; and a 4-port valve connected to the said syringe for selecting and switching flow paths.

### SUMMARY OF THE INVENTION

There is a need for the detection of particles, in particular parasites in water, e.g. drinking water or water of a swimming pool. Existing technology is based on meticulous laboratory methodology including sampling, centrifugation and molecular biology techniques. While the present invention may be used for particles in general, it is particularly suitable for parasites, and specific parasites will be used as examples and for explanatory purposes.

It is usually necessary to increase the concentration of parasites for the subsequent detection of the parasites. Existing concentration methods are technically demanding and time consuming with little possibility of automation. They often result in very low recovery rates resulting in lacking detection with conventional methods. More effective conventional systems disrupt the parasites, impeding subsequent detection of the parasites.

It has surprisingly been discovered that on-line detection of parasites may be achieved by increasing the concentration of the parasites, without disrupting the integrity of the parasites.

The present invention relates to a device and a method for concentration of particles from a volume of liquid. The invention more particularly relates to a device and a method for concentration of protozoan contaminants from a volume of water.

Drinking water quality is monitored around the world to ensure that citizens are not infected with protozoan contaminants, but the known methods for analyzing water for protozoan contaminants are manual and very time consuming. Accordingly, there is risk that people will be infected before an alarm strikes.

There is an urgent need for automated rapid analysis systems for monitoring water for occurrences of protozoan contaminants such as Cryptosporidium oocysts and Giardia cysts. One of the main challenges in making an apparatus of such sort, is the fact that the medically harmful concentration of these organisms is as low as approximately 10 per litre. This means that it is impossible to make analysis without significant concentration of the drinking water.

Normal means for concentration of water containing protozoan contaminants is by filtration of a larger volume of water and by rinsing same filter in to a smaller volume of water in such a way that contaminants are moved from the filter into said smaller water volume. Normally a concentrated sample of 1 ml or less is needed for analysis which means that said smaller water volume used for rinsing the filter needs to be concentrated additionally. This is typically done by centrifugation and following removal of water. Hereby bottom sediment of needed volume is available.

All these manual steps are not only time consuming but also ineffective in terms of recovery rate. Due to the filter type, the method of rinsing the filter and the many manual handling steps, the recovery rate of the traditional way of concentrating water for this purpose is between 30-50%. This means that only 30-50% of the contaminants caught on the filter end up in the sample used for analysis. Furthermore, a downside to this type of concentration is, that irrelevant particles smaller that the sought contaminants are accumulated on the filter and thereby in the sample for analysis, despite the fact that the pore size of the filter should allow them to pass. It is well known that particles smaller than the pore size of a filter will be retained due to clumping and other phenomena.

Ultrasound cleaning baths are well known for their ability to gently clean submerged items such as filters very efficiently and the literature shows record of tests where ultrasound cleaning baths are used as a method for rinsing protozoan contaminants of filters for later collection. These ultrasound cleaning baths are driven by one or more ultrasound transducers that are attached to the tank wall and make this tank wall vibrate at 20-100 kHz depending on type of cleaning. The vibration in the water volume causes imploding cavitation bubbles that create multiple high velocity jets in arbitrary directions. These jets have the ability to remove particles and dirt from surfaces mechanically. It is critical for the cleaning process that the item, subject to the cleaning, is totally wetted and that no air or gas bubbles are present. Air bubbles in the water will decrease the cavitation and thereby the cleaning significantly.

Ultrasonic cavitation in water is also well known as a method for smashing cell walls to harvest proteins and/or DNA in laboratories. Ultrasonic cleaning of protozoan contaminants from filters has to be carefully adjusted so that their recognisability and usability is not compromised.

It is an object for the present invention to specify a concentration device and a method that enables automated and rapid concentration of particles.

It is further an object of the present invention to specify a concentration device and a method that makes it possible to carry out automated and fast concentration of protozoan contaminants from a volume of water.

These and other objects and advantages of the present invention will be apparent from the following description and the appended claims.

The objects of the present invention can be accomplished by a method and a concentration device as described in the claims.

According to an aspect, the invention concerns a method for detecting particles such as parasites in water, said method comprising: Passing at least a part of the water through a filter; Applying indirect sonication with ultrasound to said filter to release parasites which have been collected in said filter without disrupting said parasites; Collecting parasites; and Detecting the collected parasites. Ultrasound may be applied in order to release parasites collected in the filter and/or increase the concentration of parasites before the filter and/or disrupt aggregates without disrupting the parasites per se.

According to an aspect, the present invention concerns the use of indirect sonication on a filter to release parasites without disrupting the parasites. The parasites may subsequently be detected.

According to an aspect, the present invention concerns an online reagentless detector for parasites in drinking water or swimming pools.

According to an aspect, the present invention concerns a reagentless online Cryptosporidium and Giardia sensor for continuous water quality monitoring that can detect parasites in drinking water within less than two hours and thus prevent pollutions with Cryptosporidium and Giardia from reaching the consumers.

The number of particles in the relevant size range (3-20 μm) in regular water supply is expected to exceed the number of Cryptosporidium and Giardia by several logs. This makes the risk of false positive results very high, putting extreme demands on the specificity of the sensor. Positive readings should usually be confirmed by conventional methods. Furthermore, in case of true positive findings there is a need to collect parasite DNA in order to make the necessary species identification and typing that will allow outbreak investigations to trace the source of the pollution and thereby stop the contamination. In the present day situation collection of parasite material for this purpose would be done by labour intensive and time consuming methods.

According to an aspect, the present invention concerns a sample collection unit that may be in flow communication with a reagentless parasite sensor.

According to an aspect, the concentration device according to the invention is a concentration device for filter filtration concentration of particles from a volume of a fluid, which concentration device comprises a filter configured to filter particles of a predefined size in the volume of the fluid. The concentration device comprises an ultrasonic transducer that is configured to clean the filter.

### DETAILED DISCLOSURE

The term “retentate” refers to the part which is retained in a filtration process, for example by a filter or porous membrane (as opposed to the “diffusate”).

By “indirect ultrasonication” is meant that ultrasound is applied to a filter or membrane, opposite the side of collection of e.g. parasites. Indirect ultrasonication is applied on the diffusate side of a filter or membrane.

The term “particles” comprise, but is not limited to, particles of sand, clay, ocher and other iron oxides, and also biological particles, such as bacteria, viruses, parasites, in particular protozoa, fungi, DNA, RNA, proteins, toxins, and further other particles including immunomagnetic beads, molecular probes, and molecules.

While the invention may be used for particles in general, the invention is particularly relevant for biological particles.

The expression “without disrupting” means that the particles are sufficiently intact or unharmed to allow subsequent identification and thus detection with the selected detection method. E.g. when visual detection is used, the collected particles should be sufficiently unharmed to allow visual detection of the particles.

According to an embodiment, the invention concerns a concentration unit or concentration device which comprises a filter and means for indirect sonication of said filter with ultrasound, i.e. indirect ultrasonication. The terms “concentration unit” and “concentration device” will be used interchangeably.

According to an embodiment, the invention concerns a method, wherein the space before the filter constitutes a first volume and the space after the filter constitutes a second volume. The space before the filter is the space or volume from which water enters the filter, i.e. on the retentate side of the filter. The space after the filter is the space or volume from which water departs from the filter, after having passed the filter, i.e. on the diffusate side of the filter.

According to an embodiment, the invention concerns a method applying dead-end filtration.

According to an embodiment, the invention concerns a method, wherein the filter is a polycarbonate or metal filter, preferably a nickel filter. Preferably an electroformed nickel screen is used. Preferably a filter with homogenous hole densities is used.

According to an embodiment, the invention concerns a method, wherein the filter has a pore size of at least 2 μm, more preferred at least 2.5 μm, preferably at least 3 μm.

According to an embodiment, the invention concerns a method, wherein the filter has a pore size of at most 4 μm, more preferred at most 3.5 μm, preferably at most 3 μm.

According to an embodiment, the filter preferably has a pore size of about 3 μm. The optimal pore size may be adjusted according to the applied pressure on the retentate side of the filter.

According to an embodiment, the invention concerns a method, wherein an ultrasound transducer applying indirect sonication to said filter is positioned 0.5-200 mm, preferably 0.7-100 mm, more preferred 1.0-50 mm, preferably 1.2-25 mm, more preferred 1.5-10 mm, preferably 1.6-8 mm, more preferred 1.8-6 mm, preferably 2-4 mm, more preferred about 3 mm from said filter.

Preferably the driving surface of an ultrasonic transducer extends parallel to and is configured to send ultrasonic sound waves towards the filter. Preferably the filter extends substantially perpendicular to the longitudinal axis of the transducer.

According to an embodiment, the invention concerns a method, wherein the collected parasites are detected within less than 12, more preferred less than 8, preferably less than 6, more preferred less than 4, preferably less than 2 hours. Rapid detection allows impeding pollution from reaching consumers.

According to an embodiment, the invention concerns a method for monitoring parasites in water, such as Giardia and Cryptosporidium as the most common pathogenic protozoa in drinking water. For surface water and spring water the monitoring of parasites is of special importance.

According to an aspect, the present invention concerns a reagentless online Cryptosporidium and Giardia sensor for continuous water quality monitoring that can detect parasites in drinking water within less than two hours and thus prevent pollutions with Cryptosporidium and Giardia from reaching the consumers.

According to an embodiment, a device or system of the invention may comprise several components:

1. An known sensor, such as an optical sensor system, comprising:
a. Hardware consisting of a mobile microscope scanning a reading chamber or flow cell.
b. Software comprising a control system, algorithms for automatic visual identification of parasites, and file storage for documentation.

2. A computer unit, comprising:
a. Conventional hardware.
b. Software controlling water flow (opening and closing of valves etc), sonication etc.

3. A fluidics system, comprising elements such as:
a. Tubing
b. Pressure control
c. Valves
d. A concentration unit, e.g. according to the present invention
e. A flow cell, e.g. according to the present invention
f. A sample collection unit, e.g. according to the present invention

According to an embodiment, the system is able to monitor process water in industry and food production as well as monitor waste water, source water and/or water distribution systems.

The applications for this system comprise, but are not limited to, early warning of source water contamination and/or variation. As examples may be mentioned water plants/water distribution networks, filtration systems (water purification), commercial buildings, swimming pools, waste water effluent, and industry in general.

According to an embodiment, while fluid is filtered, parasites are collected by a filter of a predefined pore size that allows the collection of parasites of specific size range. The geometry of the filtration unit coupled with sonication allows filtration of large quantities of fluids and sampling of desired particles in the smallest possible volume without pronounced change on morphology of collected particles in the retentate.

According to an embodiment, the ability of the filtration unit to concentrate particles present in large quantity of fluid is further improved by relocating the retentate to an examination or detection chamber by air without diluting the concentrated sample.

According to an embodiment, a flow cell is provided. The flow cell connected to a sensor is designed to fit the optical and physical needs of the sensor and the special requirements for examination of water borne microorganisms. This flow cell is designed also to withstand harsh environmental conditions to be able to function in remote area with lowest requirements for maintenance. Specific and sensitive detection of water borne parasites is ensured by the sensor technology.

According to an embodiment, the sensor ensures collection of desired samples for further examination in the laboratory that fits with delicate examination methods, for example DNA typing.

According to an embodiment, a sensor measures the total number of particles in a water sample. Accordingly, it may differentiate between organic and inorganic objects, and measure the size and eccentricity of each object. Eccentricity is defined as the ratio of shortest to longest dimension of the object. Preferably, in addition to inorganic particles the sensor also identifies and counts the two most common pathogenic protozoa, Cryptosporidium and Giardia.

According to an embodiment, a sensor may detect and output a number of parameters regarding water quality, which usually requires several different instruments to measure. Output parameters may include: Total object count, differential count of organic and inorganic particles, differential count of pathogenic protozoa Cryptosporidium and Giardia, size and eccentricity distributions, object mobility (for identifying actively moving bacteria), and/or turbidity.

According to an embodiment, the system may be designed to operate in a harsh environment at remote locations, which sets a number of requirements on the technology, including: No manual sample preparation, no use of staining or other types of reagents as these needs to be replaced regularly, real-time monitoring in order to be able to respond quickly to contamination events, rugged technology which operates at a wide range of temperatures and humidity levels, and/or long intervals between service, maintenance, and calibration.

According to an embodiment, the subsequent analysis of each object is done by defining a number of morphological features such as object size, contrast, and width/length ratio. In more complex applications such as identifying Giardia parasites in surface water containing other types of objects more morphological parameters may be used.

According to an embodiment, a method of the invention may be used for water supplies, water works and water distribution networks. Additional potential applications includes: Water plants / distribution networks; monitoring of potable water in buildings, such as hospitals, hotels, shopping malls, retirement homes; circulation systems, early warning of Legionella contaminations; industry source and waste water; rain/grey/waste water re-use systems; and/or swimming pools.

A reagentless parasite sensor, e.g. of the invention, may be dependent on the ability to concentrate parasites from a large volume of water (e.g. litres) into a small volume of water (e.g. micro litres) in order to obtain the necessary sensitivity. The sensitivity is defined by the minimal infective dose that can cause disease, approximately 10-1000 parasites constitute a risk for normal healthy individuals (Okhuysen P C, Chappell C L, Crabb JH, Sterling C R, DuPont H L. Virulence of three distinct Cryptosporidium parvum isolates for healthy adults. J Infect Dis. 1999 October; 180(4):1275-81. RENDTORFF R C, HOLT C J. The experimental transmission of human intestinal protozoan parasites. IV. Attempts to transmit Endamoeba coli and Giardia lamblia cysts by water. Am J Hyg. 1954 November; 60(3):327-38). A realistic estimate is that this corresponds to infectious concentrations of as little as 10 parasites/L, assuming that one person consumes 1 L of drinking water per day.

The example calculation below identifies a number of important modifiers of sensitivity that have been addressed in the concentration device or in other parts of a reagentless parasite sensor.

The filtration of e.g. 10 L, or more preferred 20 L, water per 40 min through a small filter places several demands on the design of the unit, such as:
Pressure robustness of filter
Durability of filter
Reduction of risk of clotting of the filter due to particles and microorganisms, including biofilm. The risk of clotting is influenced by factors unrelated to the concentration unit including water quality (purity inorganic, organic and biological). Accordingly, the invention may be tailored to particular water sources.

Recovery of parasites is usually far from 100% with conventional methodology. Recovery of approximately 80% of parasites, as obtained with a present concentration device, is unprecedented.

Transport of sample from concentration device to flow cell without dilution of the concentrate is challenging. This has been solved in a concentration device according to an embodiment of the invention.

Visual detection is demanding, in particular because there will be a large excess of particles in the same size range as the parasites. The quality of the concentrate that is fed to the sensor is dependent upon the concentration device.

Equal distribution of parasites is unlikely due to their ability to aggregate. According to an embodiment, repeated filtration of large water volumes and the use of ultrasonication to disrupt aggregates addresses this problem.

Acknowledging the above mentioned limitations of conventional technology, i.e. recovery, fluidics, detection, and distribution, it may be estimated that the detection limit in a sample will not achieve the goal of being better than 10 parasites per L. Thus, without the concentration unit sensitivity would be far lower, making the concentration unit a key element for developing the proposed reagentless sensor with the demanded detection limit.

Existing concentration methods, including filtration techniques, give variable and generally low recovery of parasites and many of the techniques are labour intensive and time consuming.

According to an embodiment, a filtration unit has been carefully designed to ensure optimal recovery of Giardia cysts and Cryptosporidium oocysts. This has been done by a number of inventive features.

According to an embodiment, the invention concerns filtration in a filter that may be selected among commercially available products to an ideal thickness, pore size, and pore number per area retaining all size variants of Giardia and Cryptosporidium and allowing passage of smaller organisms, including bacteria.

According to an embodiment, the invention concerns choice of a metal filter that can withstand high pressure thus allowing filtration of a large water volume through a small filter (cf. FIG. 9-12d). The filter size must be kept small in order to optimise collection chamber volume (see below), and the robustness of the filter will be put under marked pressure. The filter type may be chosen after testing for robustness (cf. FIG. 9-12d). Clotting of filter could be reduced by ultrasound and several methods for application of ultrasound cleaning were tested (cf. FIG. 12a-13c).

According to an embodiment, the invention concerns using a collection chamber designed to obtain the smallest possible volume for the size of the filter.

According to an embodiment, the invention concerns ultrasound treatment of the metal filter in order to release retained parasites into the collection chamber (cf. FIG. 18a-18d) without damaging their optical characteristics and viability. The ultrasonication has been subject to intense studies (cf. FIG. 14-17), resulting in additional inventive features, comprising, but not limited to, features noted below. The requirements for testing were identified, resulting in numerous modifications of ultrasound methodology based on studies of the effects of filtration and ultrasound sonication on the parasites.

According to an embodiment, the invention concerns integration of an ultrasound generator in a filter holder.

According to an embodiment, the invention concerns applying ultrasound waves in a second chamber or volume situated on the opposite side of the filter from the collection chamber (first volume) in order to minimise harmful effects on Cryptosporidium due to direct ultrasound exposure (cf. FIG. 14-17). The use of indirect ultrasonication results in very high recovery of parasites and high viability of Cryptosporidium (cf. FIG. 16-17).

According to an embodiment, the invention concerns carefully selected ultrasound energy and timing (cf. FIG. 18a-18d).

According to an embodiment, the invention concerns transport of filtration concentrate to a detection system using air propulsion in order to avoid dilution (cf. FIG. 12a-13c).

According to an embodiment, the invention concerns choosing optimal filter type, mounting, backwash, ultrasound pulses, and other factors ensuring the long-term durability of the filter unit, avoiding clotting and reducing biofilm formation (cf. FIG. 18a-18d). Such optimization has resulted in achieving Lifetime test for 8 days, with 138240 changes in flow direction, and a total of 2626.5 L of tap water with a flow change of 230 ml/min to 204 ml/min (cf. FIG. 9-11d).

According to an embodiment, the invention concerns obtaining an increased degree of concentration (from litres to micro litres) and/or a recovery rate (80-90%), which is obtainable with this purification system. Such achievements are unprecedented when conventional parasitological techniques are used.

According to an embodiment, the concentration device according to the invention is a concentration device for filter filtration concentration of particles from a volume of a fluid, which concentration device comprises a filter allowing filtering particles of a predefined size in the volume of the fluid wherein the concentration device comprises an ultrasonic transducer that allows cleaning the filter by indirect sonication.

Devices according to the invention are particularly suited for concentration of particles, such as parasites, particularly protozoan parasites, for subsequent detection.

According to an embodiment, the concentration device according to the invention is a concentration device for filter filtration concentration of particles from a volume of a fluid, which concentration device comprises a filter configured to filter particles of a predefined size in the volume of the fluid. The concentration device comprises an ultrasonic transducer that is configured to clean the filter.

Hereby it is achieved that the ultrasonic transducer can clean the filter during filtration so that the concentration device is capable of enabling larger volume of fluid to be filtered during a given time period. A higher average flux can be achieved because the filter in the concentration device is kept cleaner.

By using a concentration device having an ultrasonic transducer configured to clean the filter, it is possible to carry out automated and rapid concentration of particles in a fluid. The concentration device is in particular capable of carrying out automated and fast concentration of protozoan contaminants from a volume of water.

The particles may be any kind of particles. The particles may be organic particles or inorganic particles. The concentration device is capable of concentrating particles of a predefined size in a fluid.

The fluid is preferably a liquid e.g. a water containing or oil containing fluid.

The ultrasonic transducer may be any kind of ultrasonic transducer capable of generating ultrasonic sound waves that can be used for cleaning the filter and/or keeping the filter clean.

It may be an advantage that the concentration device comprises a housing having a cavity which is separated into a first volume and a second volume by the filter. Hereby different inlets and/or outlets can be independently connected to the first volume and the second volume.

Preferably the filter is detachable mounted in the housing so that the filter may easily be replaced.

It may be beneficial that the housing has an inlet being in fluid communication with the first volume, and that the housing has an outlet being in fluid communication with the second volume and that the particles are concentrated in the first volume. Hereby the concentrate can easily be retained in the first volume while the filtrate is removed through the outlet in the second volume.

According to an embodiment, the invention concerns a concentration device for filter filtration concentration of particles from a volume of a fluid, which concentration device comprises a filter allowing filtering particles of a predefined size in the volume of the fluid; wherein the concentration device comprises an ultrasonic transducer that allows cleaning the filter; wherein the concentration device comprises a housing having a cavity, which cavity is separated into a first volume and a second volume by the filter; wherein the housing has an inlet being in fluid communication with the first volume and wherein the housing has an outlet being in fluid communication with the second volume, and the particles are concentrated in the first volume; and wherein the ultrasonic transducer has a driving surface arranged in the second volume.

An ultrasonic transducer comprises an active element which may be made of a piezoelectric ceramic, composite, or polymer. The driving surface is the surface of the active element. The driving surface is also known as the radiating surface, in this case the surface radiating ultrasound which allows cleaning of the filter. The front surface of the active element is usually covered with a wear plate that protects it from damage. When a wear plate is present, the driving surface of the active element is preferably arranged in the second volume, protected by the wear plate such that the active element does not come in direct contact with the filtered water. Preferably, a wear plate is mounted on the transducer that is in direct contact with water. Transducers are typically made of aluminum and a harder material is added to the driving surface to slow down erosion due to the cavitations.

It may be an advantage that the housing has a concentrate outlet being in fluid communication with the first volume and that the concentration device comprises means for pumping concentrate from the first volume out through the concentrate outlet.

Hereby the concentrate can be transported away from the first volume through the concentrate outlet. The means for pumping may be a pump, e.g. a peristaltic pump or another suitable pump.

It may be an advantage that the housing has a concentrate outlet being in fluid communication with the first volume and that the concentration device comprises means for pumping concentrate away from the first volume to an analysis device or a collection container through the concentrate outlet.

Hereby the concentrate can be transported to an analysis device or a collection container through the concentrate outlet.

It is preferred that the concentration device comprises means for providing gas or air on each side of a volume of concentrate and to pump away the volume of concentrate while keeping gas or air on each side of a volume of concentrate.

The means for providing gas or air may comprise a pump, such as a peristaltic pump, providing atmospheric air.

Hereby the concentrate can be transported out of the first volume without being diluted. Thus a high concentration of the concentrate can be maintained even when the concentrate is being transported.

It may be an advantage that the total volume of concentrate can be located in a concentrate outlet pipe and be transported out of the first volume through a concentrate outlet by pushing air into a gas inlet pipe. Hereby it is possible to control the positioning of the concentrate in the concentrate outlet pipe by controlling the amount of air or gas that is blown or pumped into the second volume.

It may be beneficial that the concentration device comprises a control unit configured to operate the ultrasonic transducer in:
an inactive state,
a first cleaning state,
a second cleaning state, and
a third cleaning state
   where the ultrasonic transducer is inactive in the inactive state and where the ultrasonic transducer in the first cleaning state transmits a first predefined number of ultrasonic waves towards the filter during a first duration and where the ultrasonic transducer in the second cleaning state transmits a second predefined number of ultrasonic waves towards the filter during a second duration and where the ultrasonic transducer in the third cleaning state transmits a third predefined number of ultrasonic waves towards the filter during a third duration when the concentrate has been removed from the second volume.

Hereby it is possible to control the ultrasonic transducer to be inactive, have a first level of activity (e.g. for cleaning during filtration) and having a second level of activity to loosen particles from the filter into the first volume and a third level of activity during cleaning of the filter after concentrate has transported away from the first volume.

Since the cleaning process is most efficient when the pressure of the fluid is low, it is preferred that the concentration device is configured to reduce the pressure of the fluid in the second volume, and preferably both in the first and the second volume, when the ultrasonic transducer is active.

It is preferred that the control device is configured to detect the flow through the inlet and/or the pressure difference across the filter that is arranged between the first volume and the second volume.

According to an embodiment, the invention concerns a method for operating a concentration device, said concentration device comprising an ultrasonic transducer and a filter, allowing sending ultrasonic pulses towards the filter of the concentration device, said method comprising:
i) Allowing the ultrasonic transducer to be in an inactive state during filtering;
ii) Optionally loosening particles trapped in the filter by sending a pulse while the device is filtering, if the pressure drop or decreased flow indicates clogging of the filter;
iii) Sending a pulse for dispersing agglomerates of particles in the filter immediately before filtration is halted;
iv) Halting filtration;
v) Sending a pulse for loosening particles into the volume of the retentate side of the filter;
vi) Recovering particles for detection; and
vii) Sending a pulse during backwash.

Preferably, a pulse of step ii) has a duration of about 1-3 seconds.

Preferably, a pulse of step iii) has a duration of about 1-3 seconds.

Preferably, a pulse of step v) has a duration of about 5-20 seconds.

Preferably, a pulse of step vii) has a duration of about 1-5 minutes, preferably several minutes.

It may be an advantage that the concentration device is configured to initiate and perform ultrasonic cleaning of the filter during filtration.

Hereby a high flux can be maintained and the concentration device can be used to concentrate large volumes of fluid.

According to an embodiment, the invention concerns a method for operating a concentration device (2), said concentration device (2) comprising an ultrasonic transducer (10) and a filter (8), allowing sending ultrasonic pulses towards the filter (8) of the concentration device (2), said method comprising initiating and performing ultrasonic cleaning of the filter (8) during filtration.

It is preferred that the concentration device is configured to automatically initiate ultrasonic cleaning of the filter during filtration on the basis of measurements of the flow through the inlet and/or the pressure gradient across the filter.

According to an embodiment, the concentration device comprises a flat filter. A flat filter may ensure uniform distance from the filtered particles to the ultrasonic transducer.

It may be beneficial that the concentration device comprises a metal filter. A metal filter can be robust and be used in different types of fluids.

It is preferred that the filter comprises an electroformed nickel screen. A filter comprising an electro formed nickel screen is robust and makes it possible to use the concentration device in different applications. Moreover, it is possible to provide electro formed nickel screens or filters that have homogeneous hole densities.

Electroforming is a metal forming process that forms thin parts through the electroplating process. The part is produced by plating a metal skin onto a base form, known as a mandrel, which is removed after plating. The main advantage of electroforming is that it reproduces the external shape of the mandrel within one micrometre. Compared to other basic metal forming processes (casting, forging, stamping, deep drawing, machining, photo etching and fabricating) electroforming is very effective when requirements call for extreme tolerances, complexity or light weight. The precision and resolution allows finer geometries to be produced to tighter tolerances while maintaining superior edge definition. Electroformed metal is extremely pure, with superior properties over wrought metal due to its refined crystal structure.

It may be an advantage that the concentration device is configured to concentrate particles in the size range between 0.1-500 μm, preferable 1-50 μm. Accordingly, it may be an advantage that the concentration device comprises a filter have openings allowing concentrating particles in the size range between 0.1-500 μm, preferable 1-50 μm.

According to an embodiment a filter of the device has openings or holes in the size range between 0.1-500 μm, preferable 1-50 μm.

It may be an advantage that the concentration device is configured to concentrate protozoan contaminants since knowledge of these particles is of great importance in relation to e.g. water quality detection.

It may be beneficial that the concentration device is configured to concentrate Cryptosporidium oocysts and Giardia cysts that are important in relation to e.g. water quality detection.

It is preferred that the ultrasonic transducer has a driving surface arranged in the second volume. Hereby it is achieved that the ultrasonic sound waves will cause imploding cavitation bubbles that create multiple high velocity jets that can be used to clean the filter.

It is preferred that the driving surface of the ultrasonic transducer extends parallel to and is configured to send ultrasonic sound waves towards the filter. Hereby the most efficient and effective use of the ultrasonic transducer can be achieved.

It may be an advantage that the filter extends basically perpendicular to longitudinal axis of the transducer.

It is an advantage to have an analysis system comprising a concentration device according to the invention. The analysis system may be configured to detect water quality. Large particles such as protozoan contaminants (e.g. Cryptosporidium oocysts and Giardia cysts) in a fluid can normally only be analysed when the fluid has been concentrated. Therefore, an analysis system comprising a concentration device according to the invention may be of great use when dealing with water quality detection.

It may be an advantage that the analysis system comprises an analysis device configured to analyse concentrate from the concentration device, a pump configured to pump concentrate from the concentration device into the analysis device. Such analysis system is capable of bringing concentrate from the concentration device into the analysis device and then analyse the concentrate. Accordingly, an analysis system of this type is highly suitable for use in water quality detection.

According to an embodiment, the method according to the invention is a method for filter filtration concentration of particles from a volume of a fluid, where the fluid is concentrated by pumping the fluid through a filter configured to filter particles of a predefined size. An ultrasonic transducer is used to clean the filter and loosen particles into a first volume, which first volume is multiple smaller than the filtered volume.

Hereby the method can be used to concentrate large volumes of fluid during a given time period. A higher average flux can be achieved because the filter in the concentration device can be kept cleaner.

It is preferred that cleaning of the filter, preferably by ultrasound, during filtration is controlled on the basis of determination(s) of flow and/or pressure difference across the filter. Determination(s) may be carried out by direct measurements, estimations or calculations based on any suitable parameters. The flow is preferably the flow through the filter. This flow may, by way of example, be measured as the flow through the inlet pipe.

It is preferred that cleaning of the filter during filtration is controlled on the basis of measured flow (through the inlet, the inlet pipe, the outlet or the outlet pipe) and/or the pressure difference across the filter.

The flow may be measured by any suitable measurement tool, e.g. a flow sensor. It is possible to measure the flow by means of a pump providing the pressure causing the flow.

The pressure difference across the filter may be measured by any suitable pressure sensor and it is possible to measure the pressure through pressure channels being in fluid communication with the first volume and with the second volume, respectively.

The method makes it possible to conduct an automated and rapid concentration of particles in a fluid. The method in particular makes it possible to carry out automated and fast concentration of protozoan contaminants from a volume of water.

It is preferred that a concentration device according to the invention is used when carrying out the method according to the invention.

It may be an advantage that the concentration device is configured to be arranged in a tilted position so that air bubbles can easily escape from the filtered fluid outlet.

All cited references are incorporated by reference.

The accompanying Figures and Examples are provided to explain rather than limit the present invention. It will be clear to the person skilled in the art that aspects, embodiments and claims of the present invention may be combined.

Additional objects and further scope of applicability of the present invention will become apparent from the detailed description given hereinafter. It should be understood, however, that the detailed description and specific examples, indicating preferred embodiments of the invention, are given by way of illustration only, since various changes and modifications within the spirit and scope of the invention will be become apparent to those skilled in the art from this detailed description.

### FIGURES

Preferred embodiments of the present invention will now be more particularly described, by way of example, with reference to the accompanying drawing, wherein:

FIG. 1a) shows a cross sectional view of the concentration device according to the invention;

FIG. 1b) shows a perspective view of the concentration device shown in FIG. 1a);

FIG. 2 shows a cross sectional view of a concentration device where fluid is being pumped into the concentration device;

FIG. 3 shows how the ultrasonic transducer is used to clean the filter in the concentration device;

FIG. 4 shows how air is blown into the concentration device;

FIG. 5 shows how the concentrate is pumped out of the concentration device without diluting the concentrate;

FIG. 6 shows how the filter is cleaned by a backwash procedure;

FIG. 7 shows an analysis system according to the invention and

FIG. 8 shows the analysis system shown in FIG. 7 while concentrate is pumped into the analysis device.

FIG. 9 shows an experimental set up that tested the robustness of the metallic filter.

FIG. 10 shows a filter in the filtration unit.

FIG. 11a-11d shows the result of backwashing.

FIG. 12a-c shows the experimental set up for testing liquid versus air backwashing.

FIG. 13a shows a filtration unit.

FIG. 13b shows the result of using air backwash.

FIG. 13c shows dilution of the red [dark] suspension.

FIG. 14-15c shows the effect of direct ultrasonication.

FIG. 16a-17c shows the effect of indirect ultrasonication.

FIG. 18a-18d shows the effect of cleaning of metallic filters by sonication.

FIG. 19 shows an embodiment of a filtration unit.

FIG. 20 shows a preferred embodiment of a filtration unit. This setup allows moving collected samples with air.

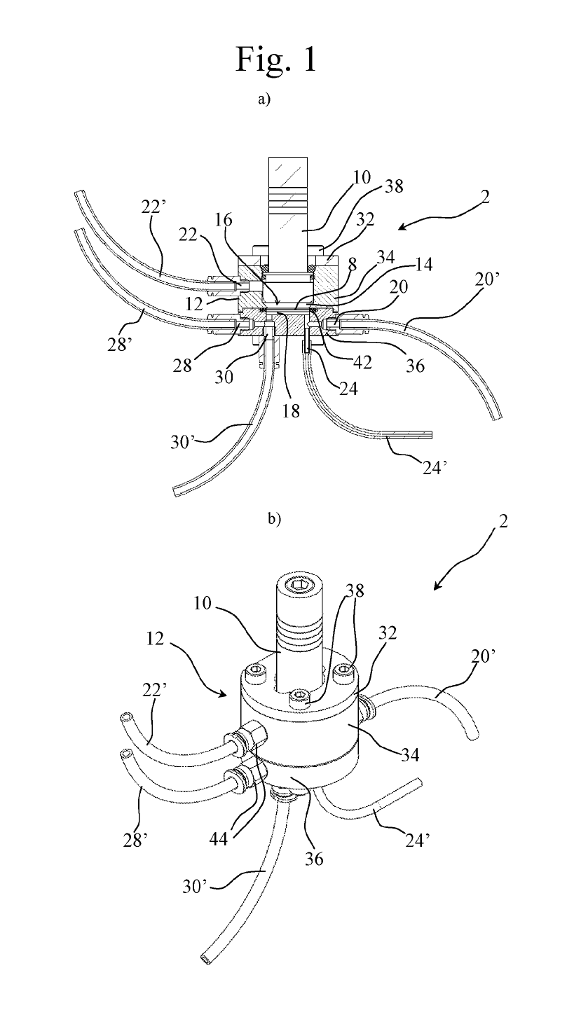

Referring now in detail to the drawings for the purpose of illustrating preferred embodiments of the present invention, elements of a concentration device 2 according to the present invention is illustrated in FIG. 1. FIG. 1 a) is a cross-sectional view of a concentration device 2 according to the invention.

The concentration device 2 comprises a housing 12 having a top member 32, a bottom member 36 and an intermediate member 34 sandwiched between the top member 32 and the bottom member 36. The top member 32 is fixed to the intermediate member 34 by means of bolts 38. The top member 32, the intermediate member 34 and the bottom member 36 may be fixed to one another by various means.

The concentration device 2 further comprises a cavity 14 having a first volume 18 and a second volume 16 separated by a filter 8. The filter 8 is mounted by means of gaskets 42 arranged in a groove provided in the bottom member 36. The filter can easily be replaced by unscrewing the bolts 38, disassembling the bottom member 36 and the intermediate member 34 of the housing 12 and removing the gaskets 42 that keep the filter 8 in place.

The concentration device 2 has an inlet 20 connected to an inlet pipe 20′. When the concentration device 2 is used to concentrate particles such as protozoan contaminants from water, the raw water enters the concentration device 2 through the inlet pipe 20′ and the inlet 20. The concentration device 2 further comprises an outlet 22 connected to an outlet pipe 22′. The outlet 22 is in fluid communication with the second volume 16 while the inlet 20 is in fluid communication with the first volume 18.

A concentrate outlet pipe 24′ is connected to a concentrate outlet 24 at the bottom member 36 of the housing 12. The concentrate outlet 24 is used when concentrate is pumped out of the concentration device 2. A gas inlet pipe 30′ is connected to a gas inlet 30 provided at the bottom member 36 of the housing. Furthermore, an outlet pipe 28′ is connected to an outlet 28 provided in the bottom member 36 of the housing 12. This outlet 28 may be used as backwash outlet during backwash procedures.

FIG. 1 b) illustrates a perspective view of the concentration device 2 shown in FIG. 1 a). It can be seen that the housing 12 comprises a top member 32, an intermediate member 34 and a bottom member 36 and that bolts 38 are used to hold the members 32, 34, 36 of the housing 12 together.

The pipes 20′, 22′, 24′, 28′, 30′ are connected to the housing 12 by means of tightening members 44 that are sealingly screwed on the housing 12.

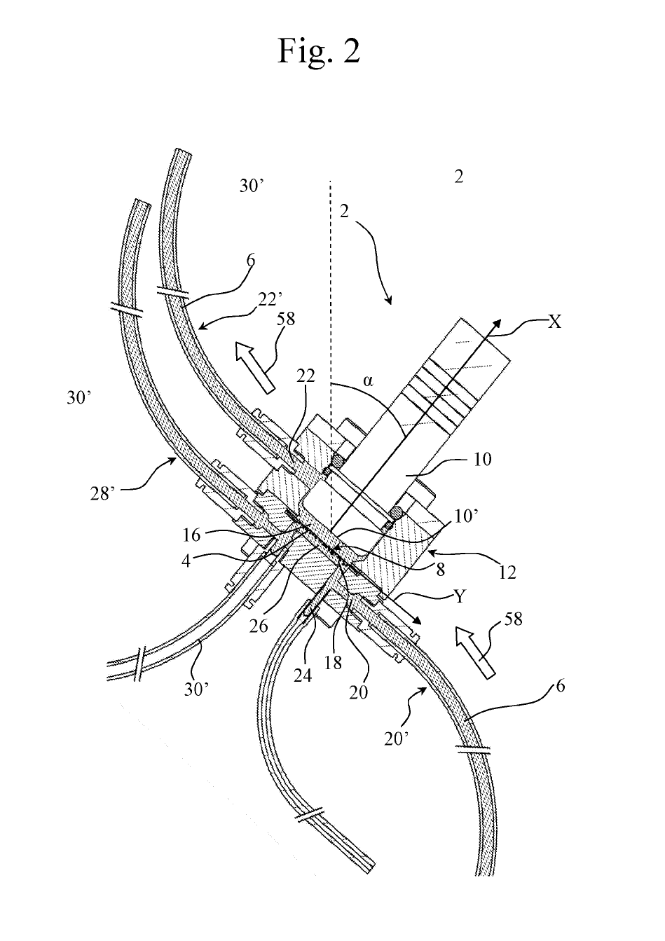

FIG. 2 illustrates a cross-sectional close-up view of the concentration device 2 shown in FIG. 1. The concentration device 2 has been tilted with a tilt angle α of about 30 degrees in order to facilitate removal of air bubbles from the filtered fluid outlet 22. It may be an advantage that the concentration device 2 is configured to be arranged in a tilted position so that air bubbles can easily escape from the filtered fluid outlet 22. The concentration device 2 may be used to concentrate different types of fluid 6. It is possible to concentrate water in order to analyse contaminants through photographing of the concentrate and image analysis. The concentration device 2 shown in FIG. 1-2 is adapted to concentration of a fluid with any size specific particles from 1 micron to 1000 micron.

In FIG. 2 raw fluid (e.g. from a water board) enters the concentration device 2 through the inlet 20 via the inlet pipe 20′. The flow direction is indicated with an arrow 58. When fluid 6 is pumped into the first volume 18 of the housing 12 with a sufficient large pressure the fluid 6 passes the filter 8, enters the second volume 16 of the housing 12 and leaves the concentration device 2 through the outlet 22. It can be seen that fluid is present in both the outlet pipe 22′, the outlet pipe 28′, in the inlet pipe 20′, and in the concentrate outlet 24. The flow direction is indicated by arrows 58.

The filter 8 is plate-shaped and extends parallel to its longitudinal axis Y that extends basically perpendicular to longitudinal axis X of the ultrasonic transducer 10. The driving surface 10′ of the ultrasonic transducer 10 is arranged in the second volume 16. Hereby the ultrasonic transducer 10 has optimal conditions for cleaning the filter 8. In order to provide an effective cleaning of the filter 8, the driving surface 10′ of the ultrasonic transducer 10 is parallel to and points to-wards the filter surface. The distance from the ultrasonic transducer 10 to the filter 8 is selected such that the ultrasonic sound waves 11 are capable of cleaning the filter 8 from particles 4 being adhered to the filter 8 by mechanically removing the particles 4 from the filter 8.

The concentration device 2 filters a given volume of fluid, e.g. water during a given time period. The duration of the time period depends on the filter size, pore size, the pressure across the filter 8, and the turbidity of the fluid 6. During filtration, the flow (through the inlet 20) and/or the pressure across the filter 8 is being monitored.

One way of keeping the filter 8 clean is to activate the ultrasonic transducer 10 when the flow has decreased to under a predefined level. The ultrasonic transducer 10 is activated to clean the filter 8 and ensure that clusters of too small particles are broken up and are passed through the filter 8.

The concentration device 2 may be configured to use ultrasonic cleaning of the filter 8 during filtration, with least possible ultrasonic activity (intensity and duration). The ultrasonic cleaning of the filter 8 in the concentration device 2 enables a larger volume of fluid 6 to be filtered during a given time period due to a higher average flux. Besides, the ultrasonic cleaning of the filter 8 in the concentration device 2 will facilitate the sorting on the surface of the filter 8 by breaking up clusters of too small particles.

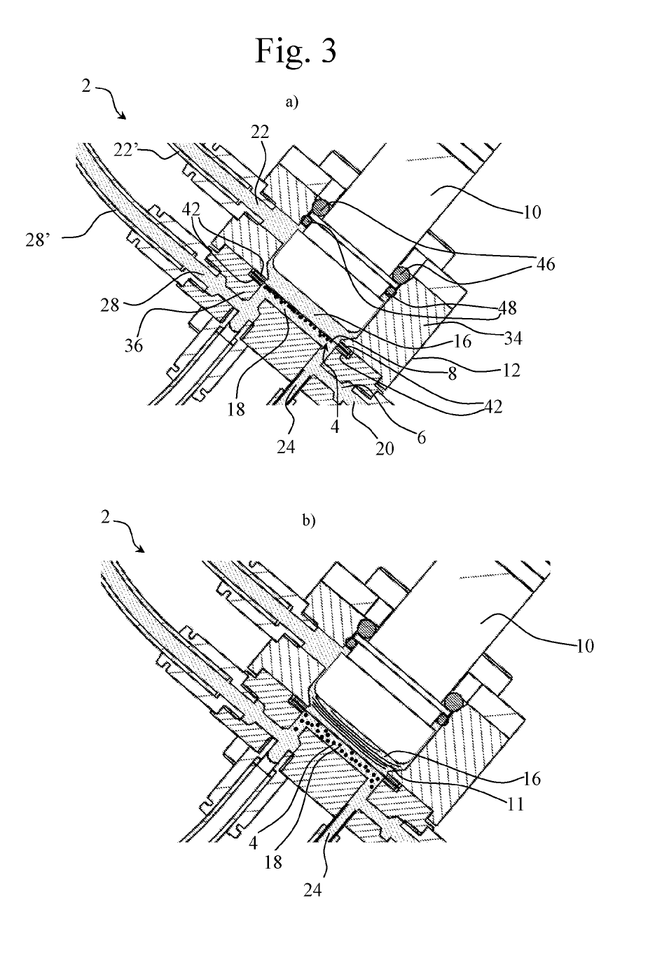

FIG. 3 a) is a close-up view of the concentration device 2 shown in FIG. 2. In FIG. 3 a) fluid 6 has been pumped into the inlet 20 of the housing 12. The fluid 6 has been filtered by being transported from the first volume 18 through the filter 8 into the second volume 16 and further through the outlet pipe 22′ via the outlet 22. Fluid 6 is also present in the backwash outlet 28, in the backwash outlet pipe 28′ and in the concentrate outlet 24.

The filter 8 is arranged between the intermediate member 34 and the bottom member 36. The filter 8 is secured to the intermediate member 34 and the bottom member 36 by means of gaskets 42.

A plurality of particles 4 have been retained by the filter 8 and these particles 4 are located close to the filter 8 at that side of the filter 8 that abuts the first volume 18. The ultrasonic transducer 10 is held in place by an 0-ring 46. Another 0-ring 48 seals the ultrasonic transducer 10 against fluid 6 from the second volume 16 and the outlet 22.

In FIG. 3 b) the ultrasonic transducer 10 is activated and the ultrasonic sound waves 11 are indicated. The imploding cavitation bubbles cause the cleaning by loosening the particles 4 from the filter 8 and distributing the particles 4 in the first volume 18. The ultrasonic sound waves 11 are only illustrating activity of the ultra sonic transducer.

The ultrasonic sound waves 11 create vibrations in the fluid in both the first volume 18 and in the second volume 16. These vibrations cause imploding cavitation bubbles that create multiple high velocity jets in arbitrary directions. These jets influence the filter 8 mechanically and hereby loosen the particles 4 from the filter 8. This cleaning process can occur when there is fluid 6 in both volumes 16, 18 and when there is no or a very small concentration of air or gas bubbles present. Air bubbles in the fluid 6, will decrease the cavitation and thereby the cleaning significantly.

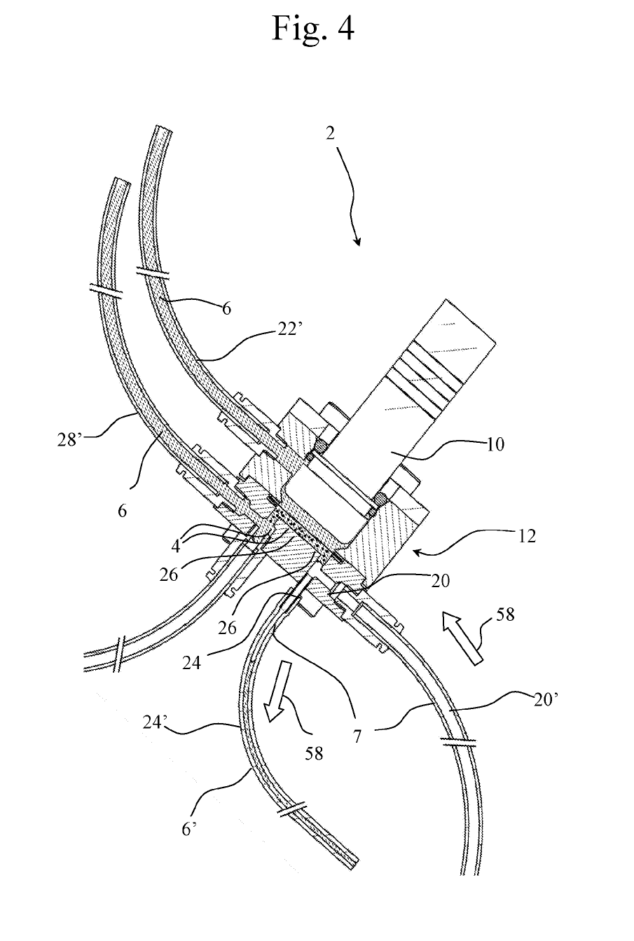

FIG. 4 illustrates how air 7 is blown into the concentration device 2. Air 7 enters the inlet 20 of the housing 12 and is further guided through the concentrate outlet 24 and further through the concentrate outlet pipe 24′. It can be seen that a volume of fluid 6′ have been pushed away from the inlet 20 and the concentrate outlet 24 towards the distal end of the concentrate outlet pipe 24′. The air 7 is used to empty the inlet 20 and the concentrate outlet 24. The flow direction of the air 7 is indicated with arrows 58.

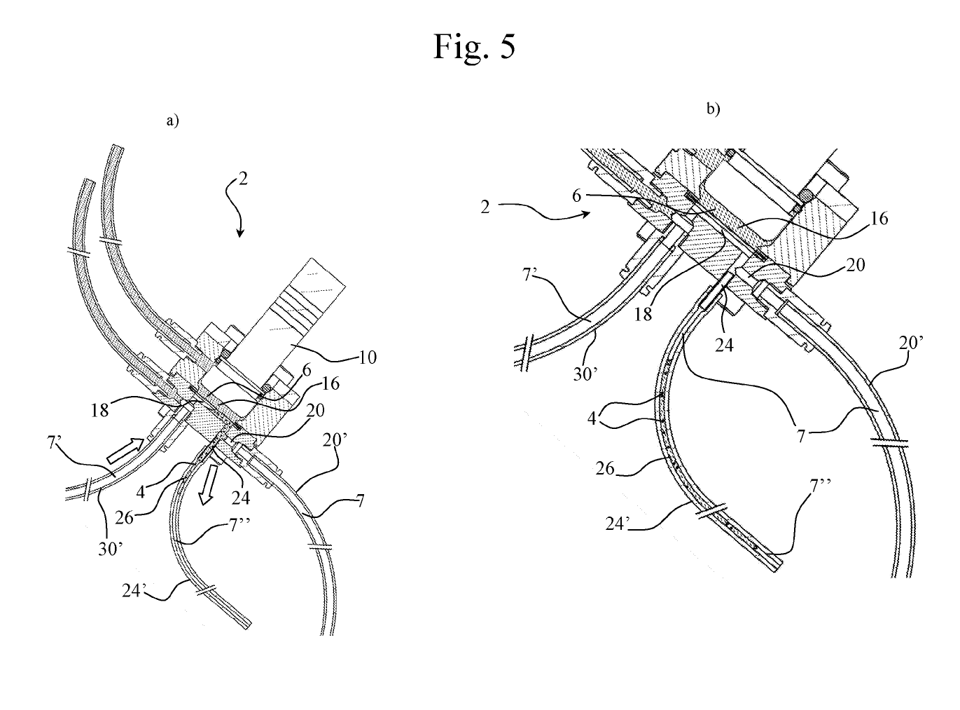

This procedure is conducted in order to prepare the transport of concentrate 26 from the first volume 18 as illustrated in FIG. 5.

FIG. 5 a) illustrates how the concentrate 26 is being transported from the first volume 18 through the concentrate outlet pipe 24′. A further analysis of the concentrate 26 can be carried out when the concentrate 26 has been transported away from the first volume 18. By way of example it is possible to analyse the concentrate 26 through photographing and image analysis.

In FIG. 5 a) there is still air or gas 7 in the inlet pipe 20′ and in the inlet 20. Additional air or gas 7′ is blown into the first volume 18 through the gas inlet pipe 30′. In FIG. 5 a) air or gas 7′ has pushed away a major part of the concentrate 26 in the first volume 18. The remaining portion of the concentrate 26 is pushed through the concentrate outlet 24 and the proximal part of the concentrate outlet pipe 24′. The filtered fluid 6 in the second volume 16 will not run back to the first volume 18 due to the pressure created by introducing air or gas 7′ into the first volume 18. Air or gas 7″ is present in the concentrate outlet pipe 24′. In fact, air or gas 7′, 7″ is introduced at both sides of the concentrate 26. Accordingly, air or gas surrounds the concentrate 26.

In FIG. 5 b) more air or gas 7′ has been pumped into the first volume 18. In fact the entire first volume is filled with air or gas 7′, which has pushed the concentrate 26 further towards the distal end of the concentrate outlet pipe 24′. In FIG. 5 b) the total volume of concentrate 26 is located in the concentrate outlet pipe 24′. Thus, the concentrate 26 is transported out of the concentrate outlet 24 by pushing air into gas inlet pipe 30′ without diluting the concentrate 26 with an additional volume of fluid. Besides it is possible to control the positioning of the concentrate 26 in the concentrate outlet pipe 24′ by controlling the amount of air or gas 7′ that is blown or pumped into the first volume 18.

The concentrate 26 is located in the concentrate outlet pipe 24′ can now be pumped further towards the distal end of the concentrate outlet pipe 24′ for further analysis (e.g. by photographing and image analysis that may be carried out in an analysis device being in fluid communication with the concentrate outlet pipe 24′).

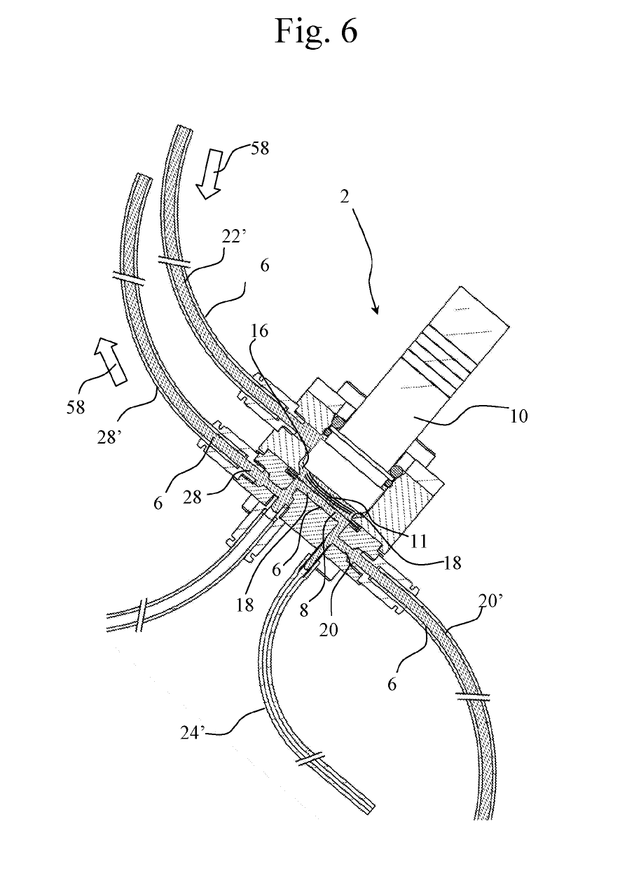

When the concentrate 26 has been transported away to the intended place, the concentration device 2 is cleaned by a backwash procedure (shown in FIG. 6).

In FIG. 6 fluid 6 is pumped into the second volume 16 through the outlet pipe 22′ and the outlet 22 (thus the outlet 22 function as inlet and the outlet pipe 22′ function as inlet pipe during this cleaning process). The fluid 6 is pumped through the second volume 16 and further through the filter and out of the backwash outlet pipe 28′ via the backwash outlet 28. The flow direction is indicated with arrows 58. The ultrasonic transducer 10 is activated and sends out ultrasonic waves 11 towards the filter 8. Hereby the filter 8 is cleaned and the ultrasonic waves 11 can tear off dirt that is stuck on the surface of the filter 8. The dirt is then transported away with the fluid 6 through the backwash outlet 28 and the backwash outlet pipe 28′.

It is possible to stop the filtering process at any time and activate the ultrasonic transducer 10 in order to clean the filter 8. However, when the concentrate 26 has been transported away to the intended place (e.g. for further analysis) the concentration device 2 is carefully cleaned by the backwash procedure described above. It is possible to measure the pressure gradient across the filter 8 and/or the flow of fluid 6 through the inlet 20 and use these measurements to decide if a cleaning process (for cleaning the filter 8) is required.

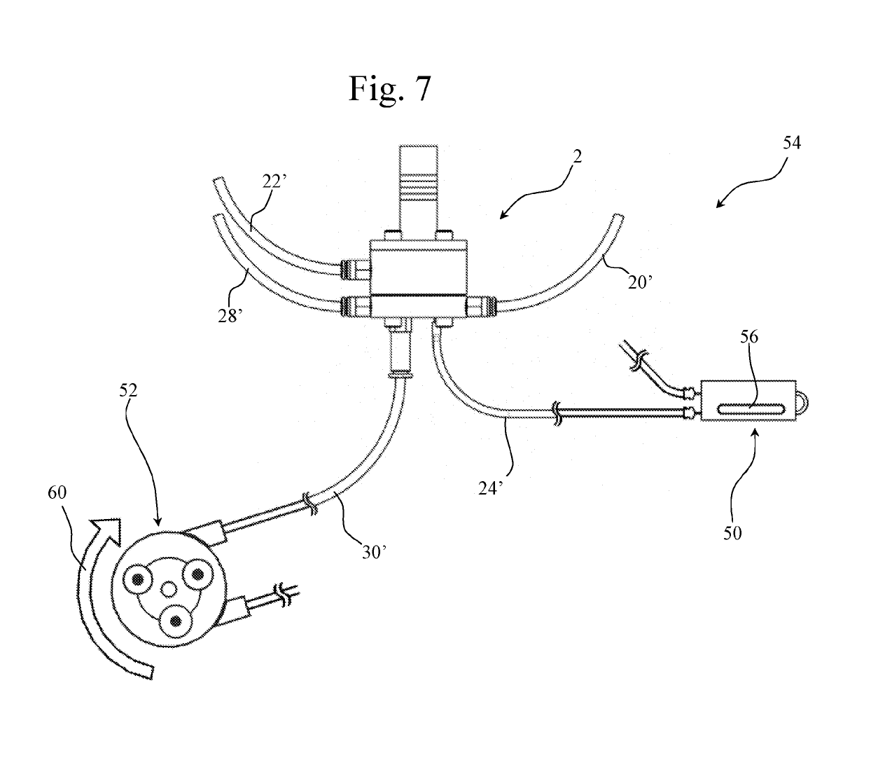

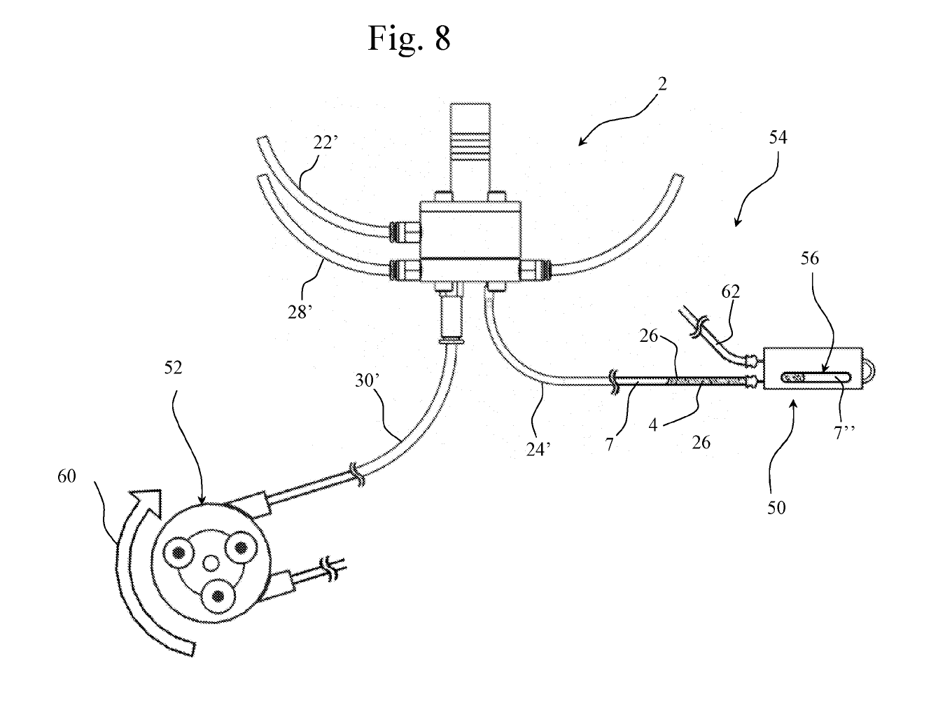

FIG. 7 illustrates a part of an analysis system 54. The analysis system 54 comprises an analysis device 50 configured to analyse concentrate from a concentration device 2 like the one illustrated in FIG. 1-6. The analysis system 54 furthermore comprises a peristaltic pump 52. Other types of pumps may be used. The pump 52 is used to pump concentrate 26 into the analysis device 50 via the concentrate outlet pipe 24′. The rotational direction 60 of the peristaltic pump 52 is indicated in FIG. 7 and FIG. 8.

A window 56 is provided in the analysis device 50. The window 56 is configured to be used in a photographing process, where the one or more images of the concentrate 26 (illustrated in FIG. 8) are recorded by using an acquiring device (e.g. a camera). Subsequent image analysis may be carried out on the basis of recorded images.

FIG. 8 illustrates the analysis system 54 shown in FIG. 7 while concentrate 26 is pumped into the analysis device 50. A portion of the concentrate 26 is visible through the window 56 in the analysis device 50.

The concentrate 26 is pumped through the concentrate outlet pipe 24′ and contains a plurality of particles 4. Air or gas 7, 7″ is provided at each side of the concentrate 26. By pumping additional air or gas 7 through the concentrate outlet pipe 24′, the concentrate 26 can be positioned in the analysis device 50 so that the concentrate 26 is visible in the window 56. In this way one or more images of the concentrate 26 can be recorded by using an acquiring device (not shown), which may be a camera. Further analysis of the one or more images of the concentrate 26 can then be conducted.

The concentrate 26 is drained away through the outlet pipe 62 when the intended analysis of the concentrate 26 has been conducted. The concentrate 26 may, by way of example, be pumped into a collecting container or drainage.

It is possible to apply a sequence of analysis steps each comprising the step of pumping a portion or volume of the concentrate 26 into the analysis device 50 and then take one or more images of the concentrate 26. When the analysis of a portion or volume of the concentrate 26 has been conducted an additional portion or volume of the concentrate 26 may be pumped into the analysis device 50 in order to take one or more images of the additional portion or volume of the concentrate 26.

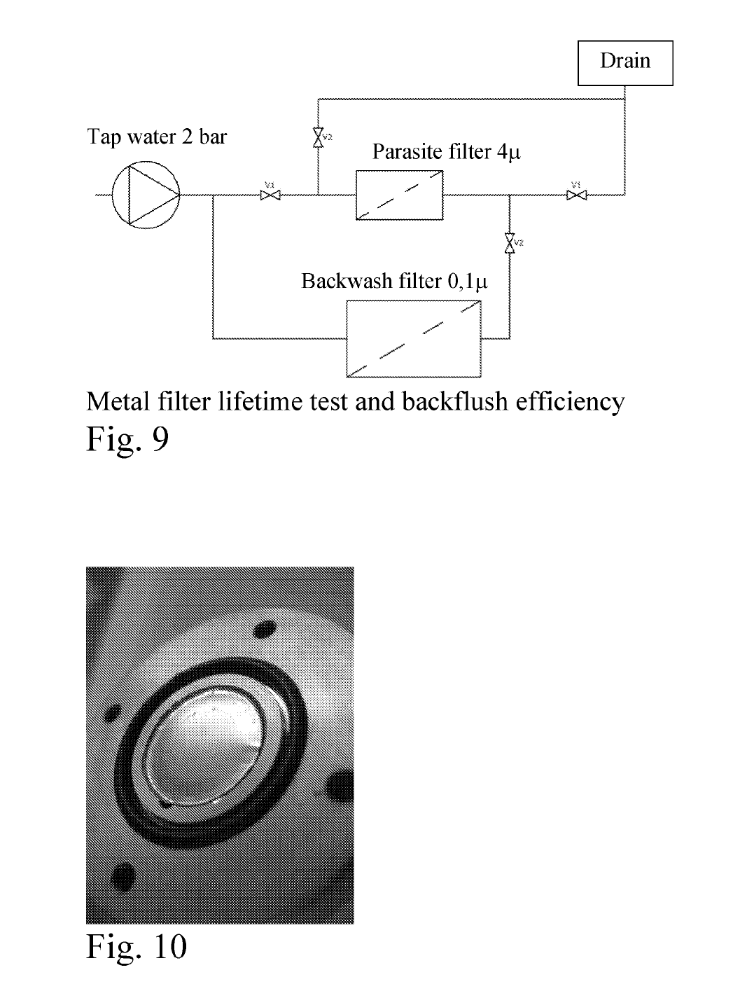

FIG. 9 is a schematic diagram showing the experimental set up of the filtration unit that tested the robustness of the metallic filter. The metal filter lifetime test and backflush efficiency was measured by a lifetimetest for 8 days, with 138240 changes in flow direction, using a total 2626,5 L water. The flow change was: 230 ml/min to 204 ml/min.

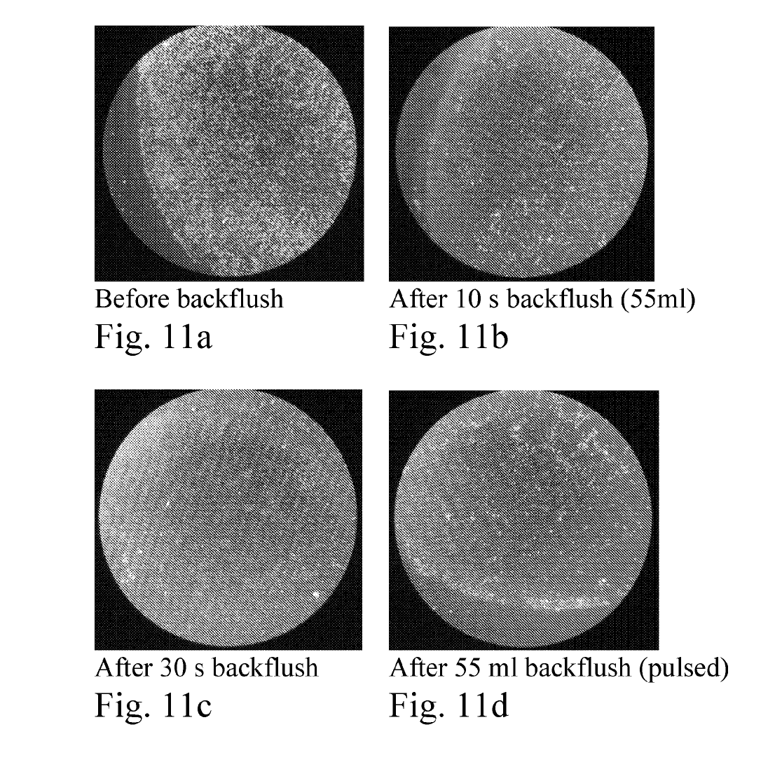

FIG. 10 shows an example of the placement of a metallic filter in the filtration unit.

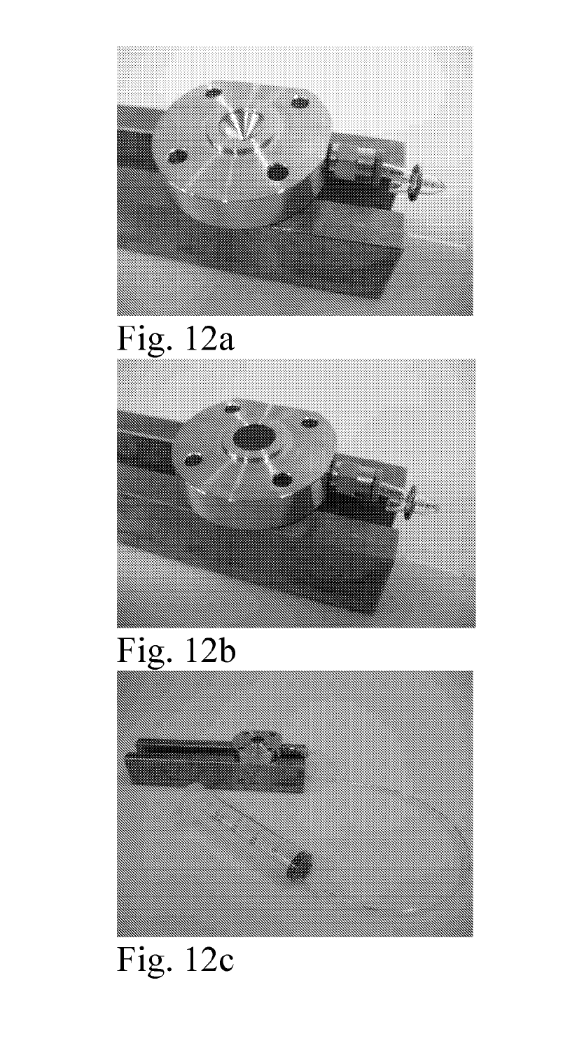

FIG. 11a-11d are four pictures that shows how backwashing alone will not result in detaching of filtered particles away from the filter even when pulse filtration is applied.

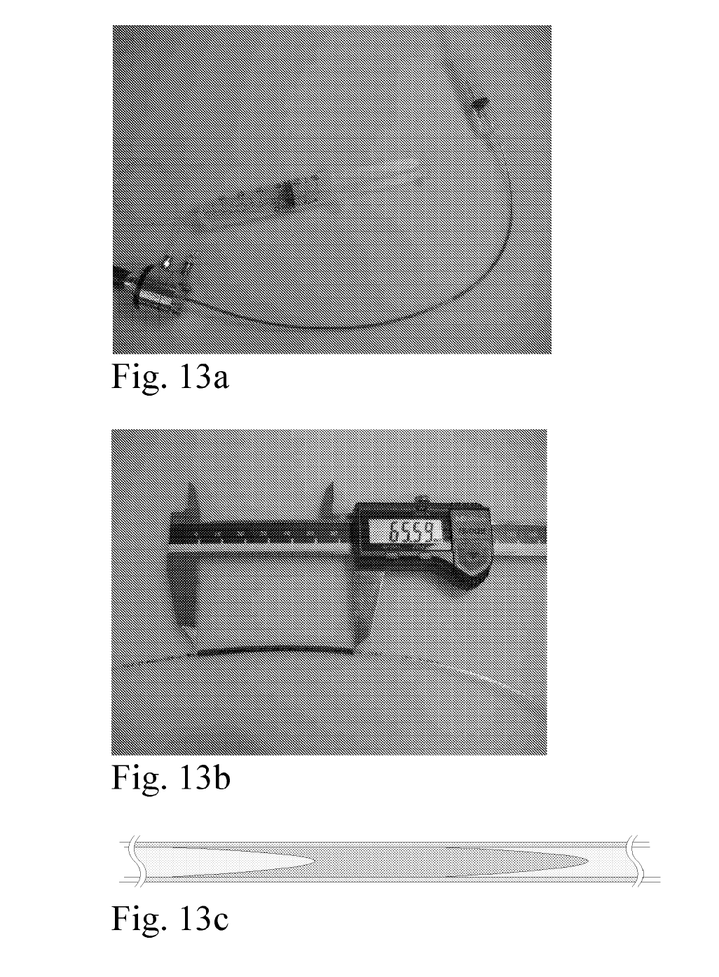

FIG. 12a-c are pictures that shows the experimental set up of testing liquid versus air backwashing of the filtrate.

FIG. 12a shows the collecting chamber located on the retentate side of the filter.

FIG. 12b shows the placement of a red [dark] fruit color fluid in the collecting chamber.

FIG. 12c shows a tube attached to a syringe that is used for retrieving the red [dark] suspension from the filtration chamber.

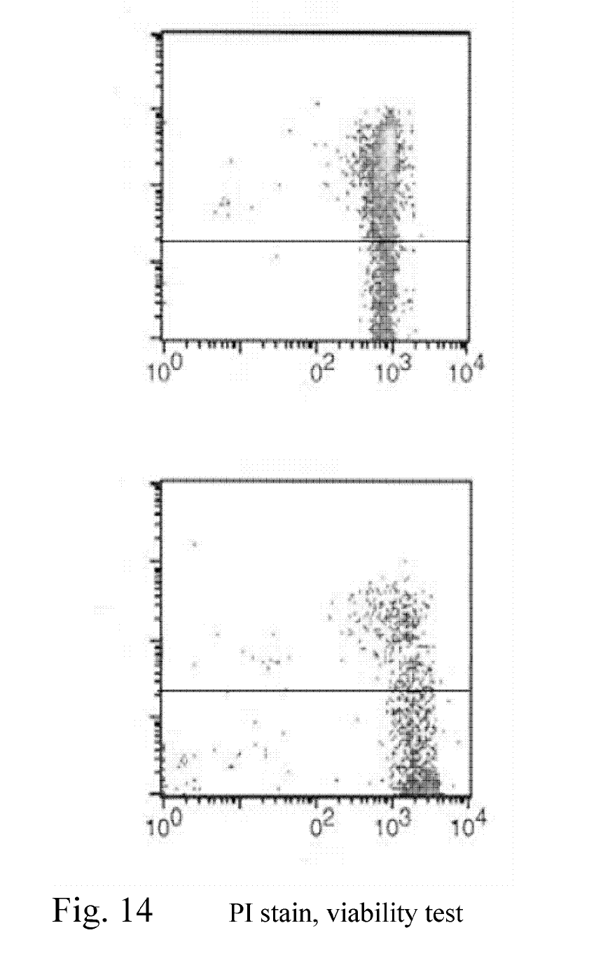

FIG. 13a shows an assembled filtration unit, with fruit color fluid in the collection chamber on the retentate side of the filter. The figure shows backwash using liquid with obvious dilution of the red [dark] suspension represented by staining of a long section of the tube with red dye.

FIG. 13b shows the result using the same test setup, using air backwash with a defined short portion of the tube being stained red [dark], corresponding to the entirety of the fruit color fluid volume being located in the collection chamber.

FIG. 13c is a schematic representation of the dilution of the red [dark] suspension.

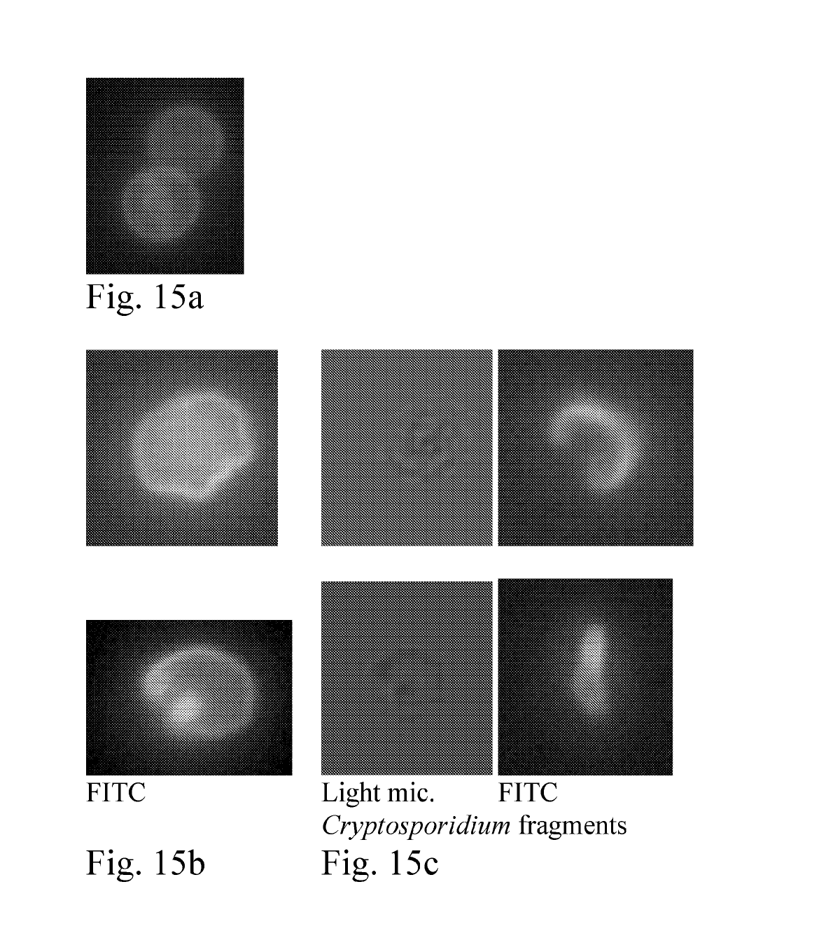

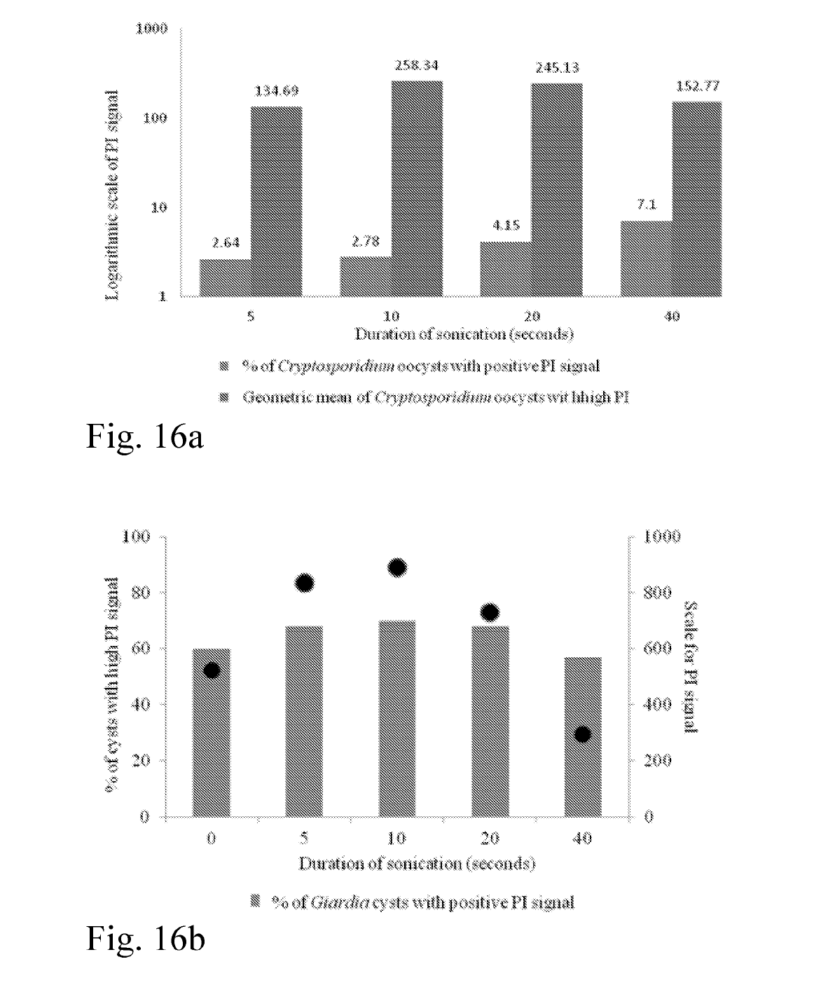

FIG. 14-15c shows the effect of direct ultrasonication.

FIG. 14 shows the results of viability test done by measuring the amount of dead DNA molecules in the parasite Cryptosporidium by measuring the intensity of a special stain (PI) that binds only to dead DNA. Thus, the PI stain (Propidium Iodide) stains dead oocysts only. X axis: Value for fluorescein isothiocyanate (“FITC”) specific stain for Cryptosporidium. Y axis: Value for PI indicator for viability.

In the upper figure, the original Cryptosporidium isolates had a geometric mean of PI value around 72, which means that around 77% of the oocysts were viable before treatment with sonication, aggregated above the dark line in the figure. The lower figure shows that after 120 seconds of sonication, we noticed a drop in counts of Cryptosporidium to around 96% and only 8% of the remaining oocysts were viable, present above the dark line of the figure, which approximately had a geometric mean of PI value of around 2. It is seen that the Cryptosporidium are moved below the line by sonication.

FIG. 15a shows the typical morphology of Cryptosporidium oocysts stained with FITC stain before treatment with sonication. FIG. 15b shows FITC stained Cryptosporidium oocysts directly sonicated for 120 seconds (2 minutes) showing obvious deformity. FIG. 15c shows many fragments of Cryptosporidium oocysts were noticed using phase contrast microscopy (left) and fluorescent microscopy (right).

The parasite count after its direct exposure to sonication was reduced by a factor of 96% and most of the recovered parasites were deformed or simply fragments as shown in FIGS. 15b and 15c.

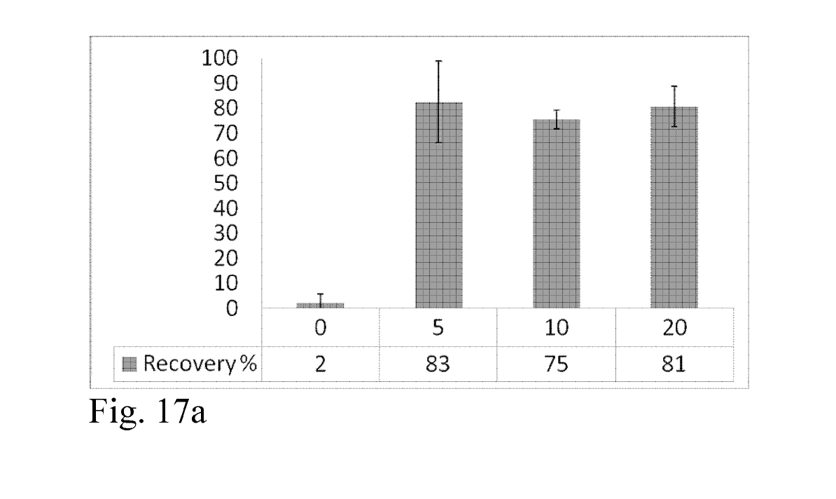

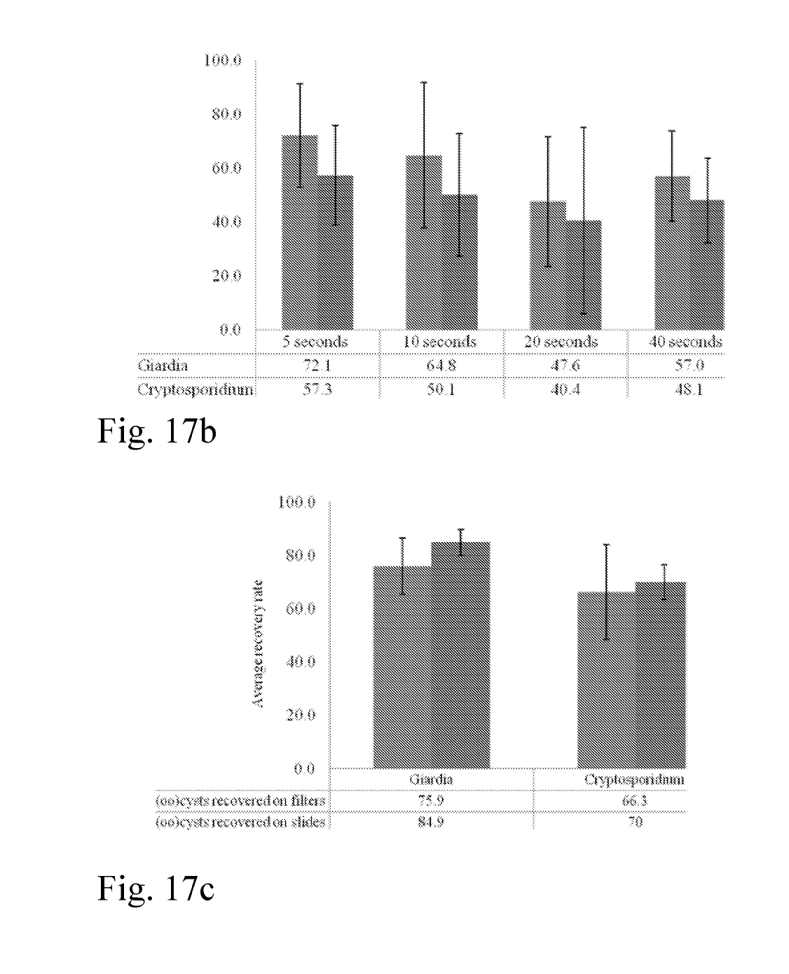

FIG. 16-17 shows the effect of indirect ultrasonication. When Cryptosporidium oocysts were indirectly exposed to sonication for a short duration the viability of the parasites was slightly affected by sonication and the percentage of parasites that showed an increase in PI value was only evident after 10 seconds of sonication.

FIG. 16a shows the effect of indirect sonication on the viability of Cryptosporidium oocysts. The Sonication time (seconds) was 5, 10, 20 or 40 seconds. Note the logarithmic scale. For each time point, five replicates of 10⁴ oocysts were used. The PI (Propidium Iodide) values discrimination between dead and living oocysts were determined by flowcytometry.

*High PI: The discrimination between dead (High PI) and living oocysts was determined optically from PI dot plot graph of original control sample.

FIG. 16b shows the effect of indirect sonication on the viability of Giardia cysts. For each time point at least 5,000 cysts were counted. The PI values (black dots) that discriminate between dead and living oocysts were determined by flowcytometry.

FIG. 17a shows the recovery of Cryptosporidium after filtration/sonication (pilot study). The horizontal axis shows Time (seconds), the vertical axis shows Recovery %. The recovered Cryptosporidium would potentially be available for detection and analysis of the parasites. About 2.3-2.7% of the seeded Cryptosporidium passed through the filters, while about 7.9-9.5% of the seeded Cryptosporidium were still trapped in the filtration unit.

FIG. 17b shows the average recovery rate (shown on the provided table) of ColorSeed™ (10 replicates) exposed to short term sonication for 5, 10, 20 and 40 seconds (+/−standard deviation). Sonicated parasites were collected in a polycarbonate membrane filters (sample collection filters) and counted manually using fluorescent microscope.

FIG. 17c shows the average recovery rate (+/−standard deviation) of ColorSeed™ exposed to short term sonication for five seconds and collected either on polycarbonate membrane filters (sample collection filters, 13 replicates) or directly mounted on slides and let for overnight dehydration (10 replicates) followed by manual counting using fluorescent microscope. Student t-test showed a significant higher recover rate of Giardia cysts than Cryptosporidium oocysts using the slide method (p<0,001).

The procedure is described as follows. To improve the recovery rate the following adjustments were implemented:
1. Before the end of the filtration period, a short interval of two seconds of sonication was applied to reduce the background noise or debris present in the filter and to remove potential air bubbles.
2. A standard counter valve was used in the filtration unit to avoid the concentrate going in the wrong direction.
3. The time between end of filtration and start of sonication was standardized (60 seconds).
4. Filtered water (0.22 urn) instead of MilliQ water was used for flushing the 1. 2 μm collection filters to reduce the amount of debris so the parasites would look clear and easy to count.

The later test was conducted using replicates (N=13) of only one time interval (5 seconds) that yielded the best recovery rate in the first test. An alternative method of collecting and counting the retained ColorSeed™ suspensions was done by placing the suspensions (N=10) directly on a specially coated epoxy slide (SuperStick™ Slides, 2 well, Catalogue nr. S100-2, Waterborne™, Inc. New Orleans, La., USA) and allowed to dry overnight at room temperature before counting.

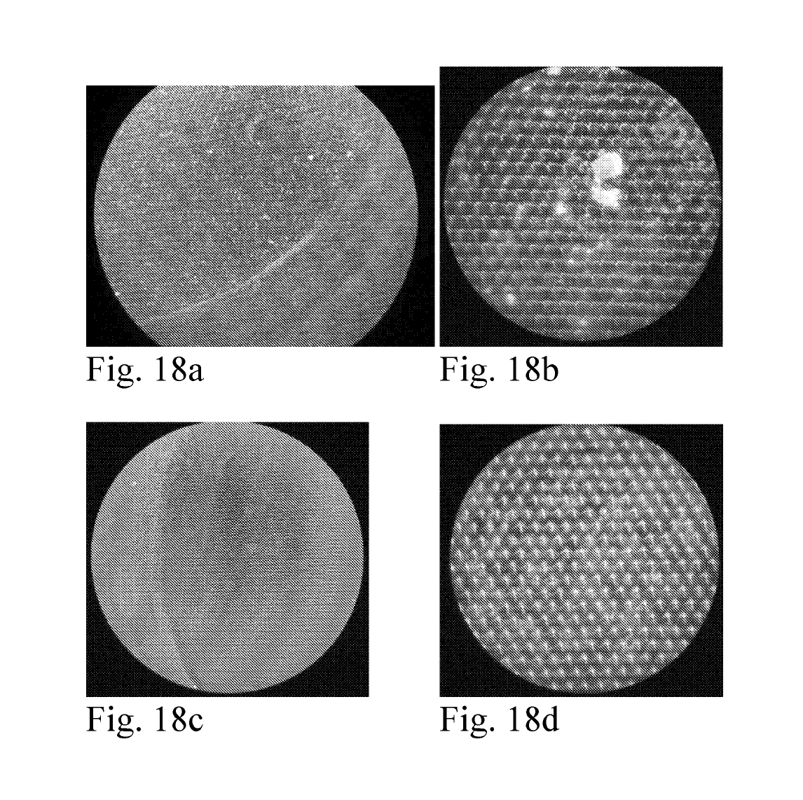

FIG. 18a-18d shows the effect of cleaning of metallic filters by sonication. An extended lifetime test with changing flow direction was performed.

FIGS. 18a and 18b: Without sonication the flux is reduced to 86% in this example, wherein the filter is shown after filtration of several liters of tap water, at different magnifications.

FIGS. 18c and 18d: Shows the same filters after 10 seconds ultrasonication (no backflush): The flux is restored to 100%.

By comparing FIG. 18b with FIG. 18c, it is shown that the removal of microscopic debris from the filter is aided by sonication. FIG. 18c shows debris of different sizes attached to the metallic filter used in the current study (pore size 3 μm) after filtration for long period which resulted in water flux reduction. After short term sonication (FIG. 18d) debris were detached from the filter by the action of water cavitations and the flux was restored to 100%.

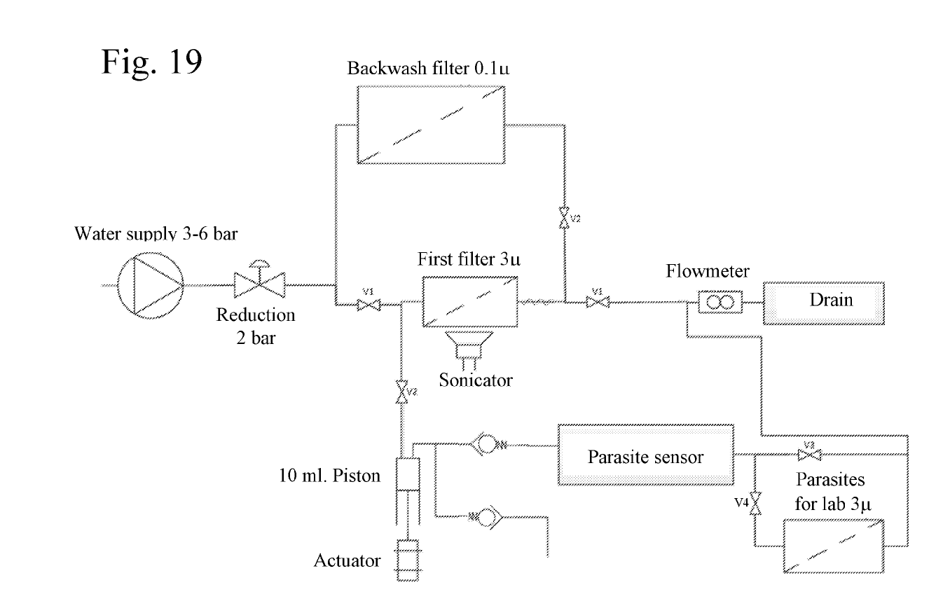

FIG. 19 is a schematic diagram showing an embodiment of a filtration unit. According to an embodiment, another loop may be added for air backwash.

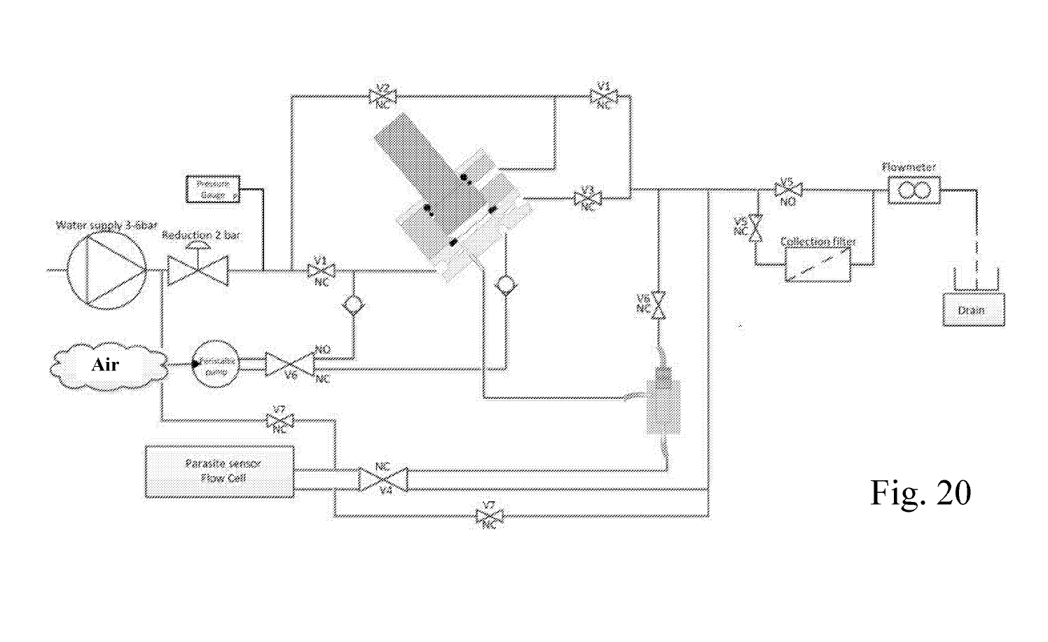

FIG. 20 is a schematic diagram showing a preferred embodiment of a filtration unit. This setup allows moving collected samples with air. While the concentrated volume collected with the setup of FIG. 19 typically would be 10 ml, the concentrated volume achieved with the setup of FIG. 20 is typically 400 μl, providing a significant improvement.

First Example of Sensitivity Calculation

Assume filtration of 10 L water during a 40 minute period where all parasites are retained in a volume of 400 μl. Screening of 16 pi of the concentrate in the flow cell of the detection system (or alternatively another detection system). Scanning of the 16 pi fluid is completed within 40 minutes. With 100% recovery of intact parasites, 100% visual recognition of parasites, equal distribution of parasites in the water, and a system to move the concentrate from the concentration unit to the flow cell without diluting the sample, this will cause a detection level of 2.5 parasites per L water in 80 minutes. When the system works continuously, performing filtration while at the same time scanning the flow cell, the sensor will generate an output every 40 minutes, allowing 36 scans per day, each with a detection limit of 2.5 parasites per L.

In the First example of sensitivity calculation, it is concluded that for a system according to the invention which works continuously, performing filtration while at the same time scanning the flow cell, the sensor will generate an output every 40 minutes, allowing 36 scans per day, each with a detection limit of 2.5 parasites per L.

Second Example of Sensitivity Calculation

Assume filtration of 30 L water during a 70 minute period where all parasites are retained in a volume of 400 μl. Screening of 80 μl of the concentrate in the flow cell of the detection system (or alternatively another detection system). Sedimentation of particles takes 35 minutes. Scanning of the 80 μl fluid is completed within 35 minutes. With 80% recovery of intact parasites as shown in a pilot study, 100% visual recognition of parasites, equal distribution of parasites in the water, and a system to move the concentrate from the concentration unit to the flow cell without diluting the sample, this will cause a detection level of 0.2 parasites per L water in 140 minutes. When the system works continuously, performing filtration while at the same time scanning the flow cell, the sensor will generate an output every 70 minutes, allowing 20 scans per day, each with a detection limit of 0.2 parasites per L, given that the water quality allows for filtration of 30 liters in 70 minutes.

In the Second example of sensitivity calculation, it is concluded that for a system according to the invention which works continuously, performing filtration while at the same time scanning the flow cell, the sensor will generate an output every 70 minutes, allowing 70 scans per day, each with a detection limit of 0.2 parasites per L.

Sample Collection Unit

According to an embodiment, a sample collection unit consists of an ordinary polycarbonate filter connected to the outlet tubing from the flow chamber through a Y-connection with valves that can be controlled by the analysis software or by the flow regulation software after receiving signals from the analysis software. For all negative readings the outlet from the flow cell will be let through one leg of the Y-connection into a waste container or drain. For all positive readings the content of the flow cell will be emptied through the other leg of the Y-connection, where it will pass through the filter, which will retain the parasite material. Through another Y-connection, the same polycarbonate filter is connected to the general water supply. In case of a positive reading, this connection will open allowing several litres (e.g. 50 L) water to pass through the filter.

In addition, all subsequent 40 minute, or preferably 70 minute, cycles with concentrates passing through the flow cell will be passed through the same filter. This allows:
1. Collection of the very same specimen that gave a positive reading. This ensures confidence in both a negative and a positive result.
2. Collection of possible parasites in a large volume of water, increasing sensitivity and yield of parasite DNA in order to ensure sufficient material for typing.

Once a positive reading has been detected an alarm may alert waterworks to collect the filter for DNA analysis. At the time of collection, this polycarbonate filter will be replaced and the system will be reset.

According to an embodiment, a sample collection unit may be used as follows:
1. Working together with the reagentless online sensor this sample collection unit will be key to securing specificity of the method and materials for typing.
2. In cases, when the sensor unit may not be able to provide the necessary sensitivity and/or specificity, the concentration unit together with the sample collection filter provide advantages, because it will allow very fast processing time and very high recovery as compared with existing methodology. Thus such a device could take over as the first step in conventional technology to ensure the highest possible sensitivity of regular spot testing.

A sample collection unit may be sold as the full equipment or the concentration unit with sample collection filter alone for different markets.

Filter and Ultrasound Transducer

First Example

A nickel filter with a diameter of 11 mm, a filter area of 95 mm², with a pore size of 3 μm is used. The filter is mounted in a filter holder. Ultrasound transducers are 6 mm away from the filter surface. The internal total volume in the filter holder is 1.74 ml. The volume on the side of the filter where parasites are captured is around 0.4 ml.

The ultrasound uses 15 Watt at 100% power. The transducer vibrates at a frequency of approximately 40 kHz.

Second Example

A second, preferred embodiment utilizes the following parameters. A nickel filter with a active filtration diameter of 17 mm, a filter area of 227 mm², with a pore size of 3 μm is used. The filter is mounted in a filter holder. Ultrasound transducer is 2-3 mm away from the filter surface. The internal total volume in the filter holder is approximately 2 ml. The volume on the side of the filter where parasites are captured is approximately 0.4 ml.

The ultrasound uses 15 Watt at 100% power and thus has an intensity of approx. 7.5 Watt/ml. The transducer vibrates at a frequency of approximately 40 kHz.

Preliminary experiments have indicated that Cryptosporidium oocysts are significantly more sensitive to ultrasonic treatment than Giardia cysts. Cryptosporidium oocysts will hereafter simply referred to as oocysts, while Giardia cysts.

Water possibly containing parasites is pressed through the filter assembly at two bar to ensure that all (oo-) cysts in hoses are washed onto the filter. Trapped parasites, which after filtering the water will sit on the surface of the filter, will be detached from the filter surface by sonication and are suspended in the surrounding fluid volume. The proportion of parasites detached from the filter surface will increase as a function of ultrasound's duration, however, parasite morphology and viability can also change as a function of ultrasound's duration. The optimal sonication time should be the time needed to free the highest number of parasites out from the filter without damaging it to the level that it will not be recognizable by a sensor. The optimal sonication time is determined by comparing counts of recovered parasites after sonication for several time points (up to 40 seconds).

As a part of a test setup, the following procedure was followed. After filtration of a specified volume of water, the filter unit is cleaned by flushing with 0.2 μm filtered water while switching on the ultrasound treatment for two minutes then backwash with around one liter of water filtered at 0.2 μm while ultrasonic cleaning is running. The water is pumped back and forth across the filter assembly that is oriented so that air bubbles can be pressed out. This is repeated until no visible air bubbles exit in the filter unit. Cleaning has duration of 15 minutes.

### LIST OF REFERENCE NUMERALS

2 Concentration device
4 Particle
6, 6′ Fluid (liquid)
7, 7′, 7″ Gas (air)
8 Filter
10 Ultrasonic transducer
10′ Driving surface of the ultrasonic transducer
11 Ultrasonic sound wave
12 Housing
14 Cavity
16 Second volume
18 First volume
20 Inlet (raw fluid inlet)
20′ Inlet pipe (raw fluid inlet pipe)
22 Outlet (filtrate outlet)
22′ Outlet pipe (filtrate outlet pipe)
24 Concentrate outlet
24′ Concentrate outlet pipe
26 Concentrate
28 Outlet (backwash outlet)
28′ Outlet pipe (backwash outlet pipe)
30 Gas inlet
30′ Gas inlet pipe
32 Top member
34 Intermediate member
36 Bottom member
38 Bolt
40 Filtrate
42 Gasket
44 Tightening members
α Tilt angle
46 O -ring
48 O-ring
50 Analysis device
52 Pump
54 Analysis system
56 Window
58 Arrow
60 Rotational direction
62 Outlet pipe

1.-44. (canceled)

45. A method for detecting particles in water, the method comprising the steps of:
(a) passing at least a portion of the water through a filter;
(b) applying indirect sonication with ultrasound to the filter to release particles which have been collected in the filter without disrupting the particles;
(c) collecting the released particles; and
(d) detecting the collected particles.

46. The method according to claim 45, wherein the particles are parasites.

47. The method according to claim 46, wherein the parasites are protozoan.

48. The method according to claim 47, wherein the parasites are selected from the group consisting of Cryptosporidium oocysts and Giardia cysts.

49. The method according to claim 45, wherein the filter has a pore size of at least 2 μm.

50. The method according to claim 45, wherein the filter has a pore size of at most 4 μm.

51. The method according to claim 45, wherein the ultrasound has a frequency of more than 20 kHz and less than 100 kHz.

52. The method according to claim 45, wherein at least 60% of the particles present in the portion of water passed through the filter are collected.

53. The method according to claim 45, wherein the water is drinking water.

54. The method according to claim 45, wherein the collected particles are detected continuously online.

55. The method according to claim 45, wherein the collected particles are detected without the use of reagents.

56. The method according to claim 45, wherein the collected particles are detected by an optical method.

57. The method according to claim 45, wherein the lower detection limit of the particles is 100 particles present in the portion of water passed through the filter.

58. The method according to claim 45, wherein step (c) comprises backwashing, backflushing, and/or transport of particles is performed with a fluid.

59. A method for releasing particles collected on a filter, the method comprising the steps of:
(a) providing a filter comprising trapped particles; and
(b) applying indirect sonication with ultrasound to the filter to release the particles from the filter without disrupting the particles.

60. A concentration device for filter filtration concentration of particles from a volume of a fluid, which concentration device comprises a filter allowing filtration of particles of a predefined size in the volume of the fluid;
wherein the concentration device comprises an ultrasonic transducer that allows cleaning the filter;
wherein the concentration device comprises a housing having a cavity, which cavity is separated into a first volume and a second volume by the filter;
wherein the housing has an inlet in fluid communication with the first volume and an outlet in fluid communication with the second volume;
wherein the first volume is suitable for concentrating the particles; and
wherein the ultrasonic transducer has a driving surface disposed in the second volume.

61. The concentration device according to claim 60, wherein the driving surface of the ultrasonic transducer extends parallel to the filter, and allows transmission of ultrasonic sound waves towards the filter.

62. The concentration device according claim 60, further comprising
(a) a concentrate outlet in the housing, the concentrate outlet in fluid communication with the first volume;
(b) either an analysis device or a collection container; and
(c) means for pumping concentrate out of the first volume through said concentrate outlet to said analysis device or said collection container.

63. The concentration device according to claim 60, wherein the concentration device comprises means for providing gas or air on each side of a volume of concentrate and for pumping away the volume of concentrate while keeping gas or air on each side of the volume of concentrate.

64. The concentration device according to claim 60, wherein the concentration device comprises a flat filter.
